(19) United States
(12) Patent Application Publication
(10) Pub. No.: US 2025/0274194 A1
(43) Pub. Date: Aug. 28, 2025

(54) APPARATUS AND METHOD FOR MONITORING ANALOG CHARACTERISTIC OF OPTICAL TRANSMITTER, AND OPTICAL TRANSMITTER

(71) Applicant: Fujitsu Limited, Kawasaki-shi (JP)

(72) Inventors: Ke ZHANG, Beijing (CN); Zhenning TAO, Beijing (CN); Tong YE, Beijing (CN); Xiaofei SU, Beijing (CN); Yangyang FAN, Beijing (CN)

(73) Assignee: Fujitsu Limited, Kawasaki-shi (JP)

(21) Appl. No.: 19/025,307

(22) Filed: Jan. 16, 2025

(30) Foreign Application Priority Data
Feb. 27, 2024 (CN) 202410218212.0

(51) Int. Cl. H04B 10/079; H04B 10/516

(52) U.S. Cl. CPC H04B 10/079; H04B 10/516

(57) ABSTRACT

An apparatus and a method for monitoring an analog characteristic of an optical transmitter may include inputting a first signal to a first electro-optical converter to obtain a optical signal to-be-measured; inputting a second signal to a second electro-optical converter to obtain a modulated local signal, so that the second signal is determined according to the first signal and a to-be-monitored analog characteristic of the first electro-optical converter; performing correlation processing on the optical signal to-be-measured and the modulated local signal to obtain at least one correlation quantity; and estimating an analog characteristic of the first electro-optical converter according to the correlation quantity. Accordingly, analog characteristic information of the optical transmitter may be extracted by using the correlation quantity between the optical signal to-be-measured and the modulated local signal, the required hardware cost is much lower than that of a conventional broadband receiver, and because there is no need to perform complex digital signal processing, power consumption is reduced greatly.

### CROSS-REFERENCE TO RELATED APPLICATIONS

This application claims priority under 35 USC 119 to Chinese patent application no. 202410218212.0, filed on Feb. 27, 2024, in the China National Intellectual Property Administration, the entire contents of which are incorporated herein by reference.

### TECHNICAL FIELD

Embodiments of the present disclosure relate to the field of optical communication technologies.

### BACKGROUND

With the development of communication technologies, imperfection of transceiver analog characteristics increasingly becomes a dominant damage affecting transmission performance of an optical communication system. By taking a 64 GBaud 64 QAM signal in a coherent optical communication system as an example, even weak IQ (In-phase/Quadrature) amplitude imbalance (such as 0.5 dB), IQ phase imbalance (such as 4°) or IQ skew (such as 0.7 ps) in a transmitter may result in a 0.5 dB Optical Signal to Noise Ratio (OSNR) cost. Therefore, imperfection of an analog characteristic of an optical transmitter needs to be monitored conveniently and accurately, and further is calibrated.

At present, optical transmitter imperfection estimation and compensation may be performed based on an equalizer of a receiver, and imperfection of a transmitter may be compensated and estimated dynamically at a receiving side. However, a range of imperfections that can be compensated and estimated by this method is limited, and this method operates after carrier phase recovery, it is easy to be affected by a channel damage, receiver optical signal to noise ratio and receiver Digital Signal Processing (DSP) operating states, thus it is not stable.

It should be noted that the above introduction to the technical background is just to facilitate a clear and complete description of the technical solutions of the present disclosure, and is elaborated to facilitate the understanding of persons skilled in the art, it cannot be considered that these technical solutions are known by persons skilled in the art just because these solutions are elaborated in the Background of the present disclosure.

### SUMMARY

The inventor finds that imperfection of transmitter analog characteristics is at a transmitting side, so an effect of compensation at the transmitting side is better than that at a receiving side. In this way, if a damage coefficient estimated by a remote receiver is fed back to the transmitter to perform analog characteristic imperfection compensation, which requires occupying an additional communication resource, and the implementation is inconvenient; and if an additional full-featured wideband receiver is deployed at the transmitting side to monitor a transmitter analog characteristic, the hardware cost and the power consumption required by a wideband receiver and a high-speed analog-to-digital converter are high.

For at least one of the above technical problems, the embodiments of the present disclosure provide an apparatus and a method for monitoring an analog characteristic of an optical transmitter, and an optical transmitter. In the embodiments of the present disclosure, correlation processing may be performed using low-speed photoelectric and electrical devices to obtain correlation of an optical signal to-be-measured and a modulated local signal, then an analog characteristic of a transmitter to-be-measured is calculated and estimated according to the correlation.

According to one aspect of the embodiments of the present disclosure, an apparatus for monitoring an analog characteristic of an optical transmitter is provided, including: a first input unit, configured to input a first signal to a first electro-optical converter to obtain an optical signal to-be-measured; a second input unit, configured to input a second signal to a second electro-optical converter to obtain a modulated local signal, wherein the second signal is determined according to the first signal and a to-be-monitored analog characteristic of the first electro-optical converter; a correlation unit, configured to perform correlation processing on the optical signal to-be-measured and the modulated local signal to obtain at least one correlation; and an estimation unit, configured to estimate an analog characteristic of the first electro-optical converter according to the correlation.

According to another aspect of the embodiments of the present disclosure, a method for monitoring an analog characteristic of an optical transmitter is provided, including: inputting a first signal to a first electro-optical converter to obtain an optical signal to-be-measured; inputting a second signal to a second electro-optical converter to obtain a modulated local signal, wherein the second signal is determined according to the first signal and a to-be-monitored analog characteristic of the first electro-optical converter; performing correlation processing on the optical signal to-be-measured and the modulated local signal to obtain at least one correlation; and estimating an analog characteristic of the first electro-optical converter according to the correlation.

According to a further aspect of the embodiments of the present disclosure, an optical transmitter is provided, including a first electro-optical converter and a second electro-optical converter, a first signal is input to the first electro-optical converter to obtain an optical signal to-be-measured; a second signal is input to the second electro-optical converter to obtain a modulated local signal, wherein the second signal is determined according to the first signal and a to-be-monitored analog characteristic of the first electro-optical converter; the optical transmitter further includes a monitoring apparatus, configured to perform correlation processing on the optical signal to-be-measured and the modulated local signal to obtain at least one correlation; and estimate an analog characteristic of the first electro-optical converter according to the correlation.

One of advantageous effects of the embodiments of the present disclosure includes: analog characteristic information of the optical transmitter is extracted by using the correlation of the optical signal to-be-measured and the modulated local signal, the required hardware cost is much lower than that of a conventional broadband receiver, and because there is no need to perform complex digital signal processing (DSP), power consumption is reduced greatly.

Referring to the later description and drawings, specific implementations of the embodiments of the present disclosure are disclosed in detail, indicating a manner that the principle of the embodiments of the present disclosure may be adopted. It should be understood that the implementations of the present disclosure are not limited in terms of a scope. Within the scope of the spirit and terms of the attached claims, the implementations of the present disclosure include many changes, modifications and equivalents.

### BRIEF DESCRIPTION OF DRAWINGS

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art may further obtain other implementations according to the drawings under the premise that they do not pay inventive labor. In the drawings:

FIG. 1 is a schematic diagram of a method for monitoring an analog characteristic of an optical transmitter in the embodiments of the present disclosure;

FIG. 2 is a schematic diagram of an apparatus for monitoring an analog characteristic of a transmitter based on parallel modulation correlation processing, in the embodiments of the present disclosure;

FIG. 3A to FIG. 3D are schematic diagrams of different types of first electro-optical converters in the embodiments of the present disclosure;

FIG. 4A to FIG. 4B are schematic diagrams of first electro-optical converters with different polarization structures in the embodiments of the present disclosure;

FIG. 5A to FIG. 5C are schematic diagrams of first electro-optical converters with different modulation structures in the embodiments of the present disclosure;

FIG. 6A to FIG. 6E are schematic diagrams of second electro-optical converters with different types and structures in the embodiments of the present disclosure;

FIG. 7 is a schematic diagram of correlation processing in the embodiments of the present disclosure;

FIG. 8 shows a possible output port of a first electro-optical converter in the embodiments of the present disclosure;

FIG. 9A to FIG. 9D are schematic diagrams of a photoelectric multiplier in the embodiments of the present disclosure;

FIG. 10A and FIG. 10B are schematic diagrams of an electrical average unit added with a function of multiplying a square wave with a frequency shift in the embodiments of the present disclosure;

FIG. 11A to FIG. 11B are schematic diagrams of a first electro-optical converter and a second electro-optical converter in the embodiments of the present disclosure;

FIG. 12 is a schematic diagram of a first electro-optical converter and a second electro-optical converter in the embodiments of the present disclosure;

FIG. 13 is a schematic diagram of a first electro-optical converter and a second electro-optical converter in the embodiments of the present disclosure;

FIG. 14 is a schematic diagram of an apparatus for monitoring an analog characteristic of a transmitter based on series modulation correlation processing, in the embodiments of the present disclosure;

FIG. 15 is a schematic diagram of a first electro-optical converter in the embodiments of the present disclosure;

FIG. 16 is a schematic diagram of series-based modulation and coherent detection in the embodiments of the present disclosure;

FIG. 17 is another schematic diagram of monitoring an analog characteristic of a transmitter in the embodiments of the present disclosure;

FIG. 18 is a schematic diagram of an apparatus for monitoring an analog characteristic of an optical transmitter in the embodiments of the present disclosure; and

FIG. 19 is a schematic diagram of an electronic device in the embodiments of the present disclosure.

### DETAILED DESCRIPTION

Referring to the drawings, through the following Specification, the above and other features of the embodiments of the present disclosure will become obvious. The Specification and the figures specifically disclose particular implementations of the present disclosure, showing partial implementations which may adopt the principle of the embodiments of the present disclosure. It should be understood that the present disclosure is not limited to the described implementations, on the contrary, the embodiments of the present disclosure include all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

Features that are described and/or illustrated with respect to one implementation may be used in the same way or in a similar way in one or more other implementations and in combination with or instead of the features in the other implementations. The term “comprise/include” when being used herein refers to the presence of a feature, a whole piece, a step or a component, but does not exclude the presence or addition of one or more other features, whole pieces, steps or components.

As everyone knows, correlation operation may realize equivalent post-receiving sampling. Assuming that there is an input pulse signal g(t), it is generated by a unit impulse signal δ(t) through a shaping function g(t), a signal after it passes through a receiver whose analog characteristic is h′(t) may be expressed as r(t)=∫_{-∞}^{∞}g(τ)h′(t−τ)dτ. Therefore, a sampling value of a received signal at the moment t₀ is r(t₀)=∫_{-∞}^{∞}g(τ)h′(t₀−τ)dτ. Similarly, assuming that there is another pulse signal h(t) at a transmitting side, it is generated by a unit impulse δ(t) through a filter whose analog characteristic is h(t), a correlation function of the pulse signals g(t) and h(t) may be expressed as G_{gh}(x)=∫_{-∞}^{∞}g(τ)h(τ−x)dτ, and when a relative delay of pulses g(t) and h(t) x=t₀, a correlation function value is G_{gh}(t₀)=∫_{-∞}^{∞}g(τ)h(τ−t₀)dτ. Obviously, if h′(t)=h(−t), i.e., h′(t₀−τ)=h(τ−t₀), there is r(t₀)=G_{gh}(t₀). Accordingly, it can be seen that sampling value of a signal after being received by a receiver whose analog characteristic is h′(t), at a receiving side is equivalent to the correlation quantity between the same signal and pulse signals whose analog characteristic is h′(−t) under different delays, at the transmitting side.

On this basis, an actual signal transmitted by a transmitter may be expressed as: E_{S}(t)=ΣₙA[n]g_{A[n]}(t−nT). When the transmitter is linear, a shaping pulse g_{A[n]}(t) is independent of a transmitted symbol or a sequence of symbols A[n] before and after it. If the transmitter has a nonlinear effect, the shaping pulse is no longer a normal pulse. Assuming that the analog characteristic of the receiver is A[n], the sampling of the received signal at moment τ is:

$${E}_{S} ( t ) ⊗ {h}^{′} ( t ) {\vert}_{τ} = \int {E}_{S} ( t ) {h}^{′} ( τ - t ) dt$$

Let h′(t)=h(−t), then ∫E_{S}(t)h′(τ−t)dt=∫E_{S}(t)h(t−τ)dt, the right side of the equal sign may further be understood as correlation of the transmitting signals E_{S}(t) and h(t−τ). That is to say, correlation operation may realize equivalent post-receiving sampling.

A high-speed signal is sampled after receiving, obviously a high-speed receiver and a high-speed ADC are required, which requires high hardware cost and power consumption. If it is converted to correlation, an integral operation is equivalent to an average operation, which may be achieved using a low-speed device. A multiplication operation may be completed using natural physical properties of optical or photoelectric devices. This makes it possible to achieve an equivalent receiver by using low-speed and low-power-consumption devices.

Since the transmitted signal is a random signal, that is, the symbol A[n] in E_{S}(t)=ΣₙA[n]g_{A[n]}(t−nT) is random. By simply correlating E_{S}(t) and h(t), a result obtained is also random, and a desired transmitter analog characteristic cannot be obtained.

In the embodiments of the present disclosure, a modulated local signal E_{L}(t)=EₘB[m]h(t−mT) may be designed, i.e., a symbol sequence B[m] is to be transmitted by a transmitter via an analog characteristic h(t). B[m] is designed according to different monitoring purposes and a transmission symbol A[m]. Correlation of E_{S}(t) and E_{L}(t) is calculated:

$$\frac{\int {E}_{S} ( t ) {E}_{L} ( t ) dt}{\int dt} = \frac{\int {\sum }_{n} A [ n ] g ( t - nT ) {\sum }_{m} B [ m ] h ( t - mT ) dt}{\int dt} = {\sum }_{n} A [ n ] {\sum }_{m} B [ m ] \frac{\int g ( t - nT ) h ( t - mT ) dt}{\int dt} = {\sum }_{n} A [ n ] {\sum }_{m} B [ m ] \frac{{g}_{Rx} ( mT - nT )}{\int dt} = {\sum }_{n} A [ n ] {\sum }_{m} B [ m ] \frac{{g}_{Rx} [ mT - nT ]}{NT} = {\sum }_{k} {g}_{Rx} [ kT ] \frac{1}{T} \frac{1}{{\sum }_{n} 1} ( {\sum }_{n} A [ n ] B [ n + k ] )$$

where, g_{Rx}(t)=∫_{-∞}^{∞}g(τ)h(τ−t)dτ=∫_{-∞}^{∞}g(τ)h′(t−τ)dτ, h′(t)=h(−t), k=m−n. (ΣₙA[n]B[n+k]) is a cross-correlation characteristic of sequences A and B, with a definite value, and is no longer random. g_{Rx} contains the analog characteristic of the transmitter, desired to be monitored. When the signal to-be-measured A[n] has good mutual correlation with the signal to-be-measured

$$B [ m ] , \frac{1}{T} \frac{1}{{\sum }_{n} 1} ( {\sum }_{n} A [ n ] B [ n + k ] ) = 0 , if k \neq 0 , so {\sum }_{n} A [ n ] {\sum }_{m} B [ m ] \frac{{g}_{Rx} ( mT - nT )}{\int dt} ∝ {g}_{Rx} [ 0 ] .$$

When the signal to-be-measured A[n] has good mutual correlation with the signal to-be-measured

$$B [ m - 1 ] , \frac{1}{T} \frac{1}{{\sum }_{n} 1} ( {\sum }_{n} A [ n ] B [ n + k ] ) = 0 , if k \neq 1 , so {\sum }_{n} A [ n ] {\sum }_{m} B [ m ] \frac{{g}_{Rx} ( mT - nT )}{\int dt} ∝ {g}_{Rx} [ T ] .$$

When the signal to-be-measured A[n] has good mutual correlation with the signal to-be-measured

$$B [ m - x ] , \frac{1}{T} \frac{1}{{\sum }_{n} 1} ( {\sum }_{n} A [ n ] B [ n + k ] ) = 0 , if k \neq x , so {\sum }_{n} A [ n ] {\sum }_{m} B [ m ] \frac{{g}_{Rx} ( mT - nT )}{\int dt} ∝ {g}_{Rx} [ xT ] .$$

Accordingly, it may be found that the correlation represents a value of an impulse response of cascade of the first electro-optical modulator and the second electro-optical modulator at the moment t, t depends on a relative delay of a signal to-be-measured and a correlation signal of the signal to-be-measured, or a relative delay of an optical signal to-be-measured and a modulated local signal. Therefore, when a monitored object is an impulse response of cascade of the first electro-optical modulator and the second electro-optical modulator, the response may be obtained via correlation processing. When an analog characteristic of the second electro-optical converter is obtained in advance, an analog characteristic of the first electro-optical converter may be calculated and reckoned according to the correlation. When the analog characteristic of the second electro-optical converter is unknown but does not change with time and environment, a characteristic that the analog characteristic of the first electro-optical converter changes with time or environment may be monitored according to the correlation.

When a transmitter may be regarded as a superposition of multiple signals, such as I branch and Q branch of a coherent transmitter, monitoring may be performed once for the I branch, and monitoring may be performed once for the Q branch, results of the two monitoring are compared, even if the analog characteristic of the second electro-optical converter is not known, difference information of the I branch and Q branch may still be obtained, i.e., IQ imbalance, because the second electro-optical converter has the same effect on the I branch and Q branch. Similar circumstances further include horizontal and vertical two-way polarizations, differences in characteristics of different segments in a modulator composed of multiple segments, differences in different bit paths in the modulator, and differences in analog characteristics between different sub-DACs of a Time-interleaving Digital-to-Analog converter (TI-DAC), as well as differences in analog characteristics of transmitters under a nonlinear condition and in case of different transmission symbol sequences.

The above text is a simple description of an idea of the embodiments of the present disclosure, and the specific embodiments are described below.

### Embodiments of a First Aspect

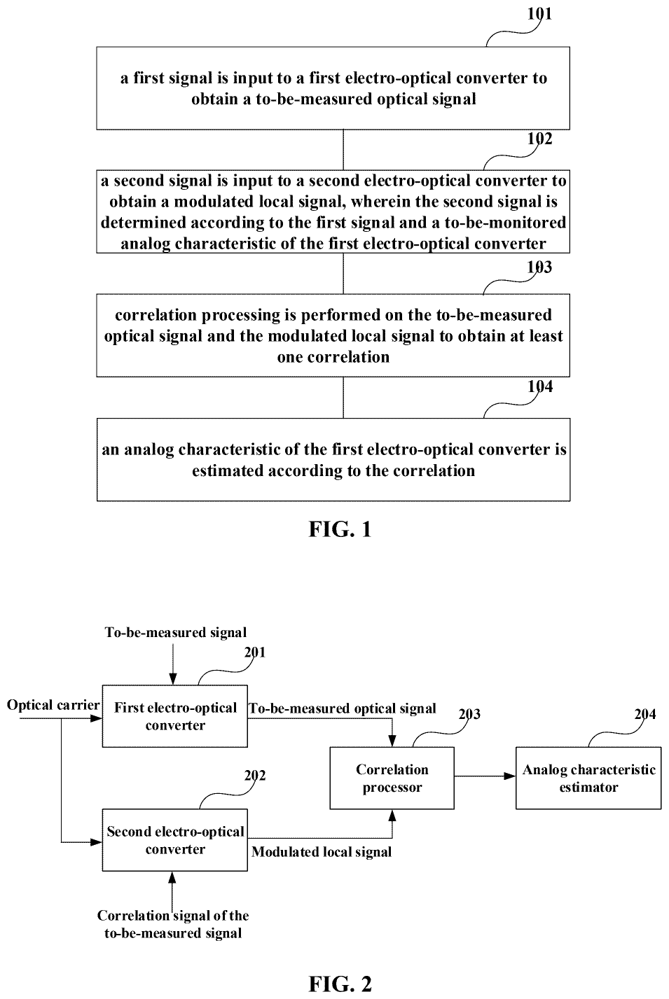

Embodiments of the present disclosure provide a method for monitoring an analog characteristic of an optical transmitter. FIG. 1 is a schematic diagram of a method for monitoring an analog characteristic of an optical transmitter in the embodiments of the present disclosure, as shown in FIG. 1, the method includes:
101, a first signal is input to a first electro-optical converter to obtain an optical signal to-be-measured;
102, a second signal is input to a second electro-optical converter to obtain a modulated local signal, wherein the second signal is determined according to the first signal and a to-be-monitored analog characteristic of the first electro-optical converter;
103, correlation processing is performed on the optical signal to-be-measured and the modulated local signal to obtain at least one correlation quantity; and
104, an analog characteristic of the first electro-optical converter is estimated according to the correlation quantity.

It should be noted that the above FIG. 1 only schematically describes the embodiments of the present disclosure, but the present disclosure is not limited to this. For example, some of the above steps may be performed simultaneously or in a sequential order, an execution step of each operation may be adjusted appropriately, moreover other some operations may be increased or reduced. Persons skilled in the art may make appropriate modifications according to the above contents, not limited to the records in the above FIG. 1.

In some embodiments, the correlation represents a value of a cascaded impulse response of the first electro-optical converter and the second electro-optical converter at a first moment, and the first moment depends on a relative delay of the first signal and the second signal.

In some embodiments, in the case of transmitting at least two superimposed signals for a transmitter, each signal is monitored at least once separately to obtain at least two correlation quantities, and an analog characteristic of the first electro-optical converter is estimated according to the at least two correlation quantities.

Structure of the embodiments of the present disclosure is first described below. There are many specific implementations of correlation processing, which may be divided into parallel-based modulation and series-based modulation according to a hardware structure relation. The following text first describes a scheme of the parallel-based modulation.

In some embodiments, the first electro-optical converter and the second electro-optical converter are connected in parallel; the first electro-optical converter generates the optical signal to-be-measured based on an optical carrier and the first signal, and the second electro-optical converter generates the modulated local signal based on the optical carrier and the second signal; the optical signal to-be-measured and the modulated local signal are respectively input to a photoelectric multiplier to obtain a product electrical signal; and the product electrical signal generates at least one correlation quantity after being electrically averaged.

FIG. 2 is a schematic diagram of an apparatus for monitoring an analog characteristic of a transmitter based on parallel modulation correlation processing, in the embodiments of the present disclosure. As shown in FIG. 2, the apparatus may include:
a first electro-optical converter 201, which is an optical transmitter per se or only a part of the optical transmitter, whose analog characteristic is a target quantity to be monitored, the first electro-optical converter 201 generating an optical signal to-be-measured;
a second electro-optical converter 202, which generates a modulated local signal according to a correlation signal of the signal to-be-measured, the modulated local signal having a certain correlation with the optical signal to-be-measured, the first electro-optical converter 201 and the second electro-optical converter 202 being in a parallel relationship;
a correlation processor 203, which performs correlation processing on the optical signal to-be-measured and the modulated local signal based on low-speed photoelectric and electrical devices, and obtains correlation quantity of the two signals;
an analog characteristic estimator 204, which estimates an analog characteristic of the first electro-optical converter according to the correlation quantity of the signals.

It is worth noting that FIG. 2 exemplarily describes structures for implementing monitoring of an analog characteristic of an optical transmitter, however the present disclosure is not limited to these structures, these structures may further be modified appropriately, and implementations of such modifications should be included within the scope of the embodiments of the present disclosure.

As shown in FIG. 2, the first electro-optical converter 201 modulates and loads an signal to-be-measured A[n] to be transmitted to an optical carrier, generates a corresponding optical signal to-be-measured and feeds it to the correlation processor 203. The first electro-optical converter 201 may be a complete optical transmitter or may be only a part of the optical transmitter.

It should be noted that the present disclosure does not impose any restrictions on a type and structure of the first electro-optical converter. For example, a physical material used by it may be lithium niobate, indium phosphide and silicon, etc. For example, it may be a coherent transmitter, may be an intensity modulation transmitter, or may be a phase modulator, or a combined signal transmitter based on an optical frequency comb.

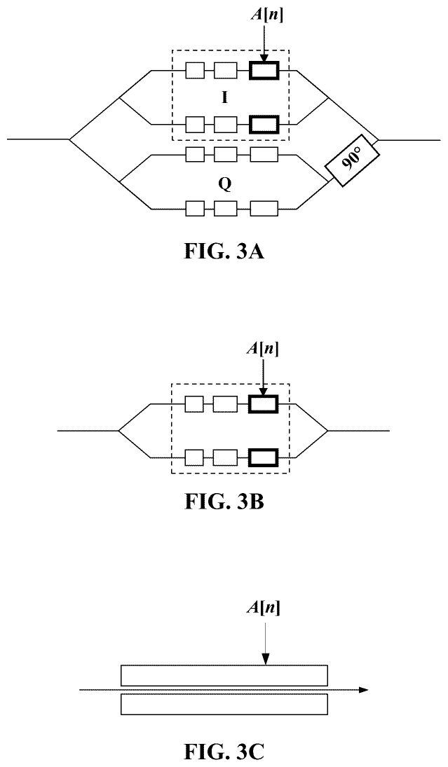

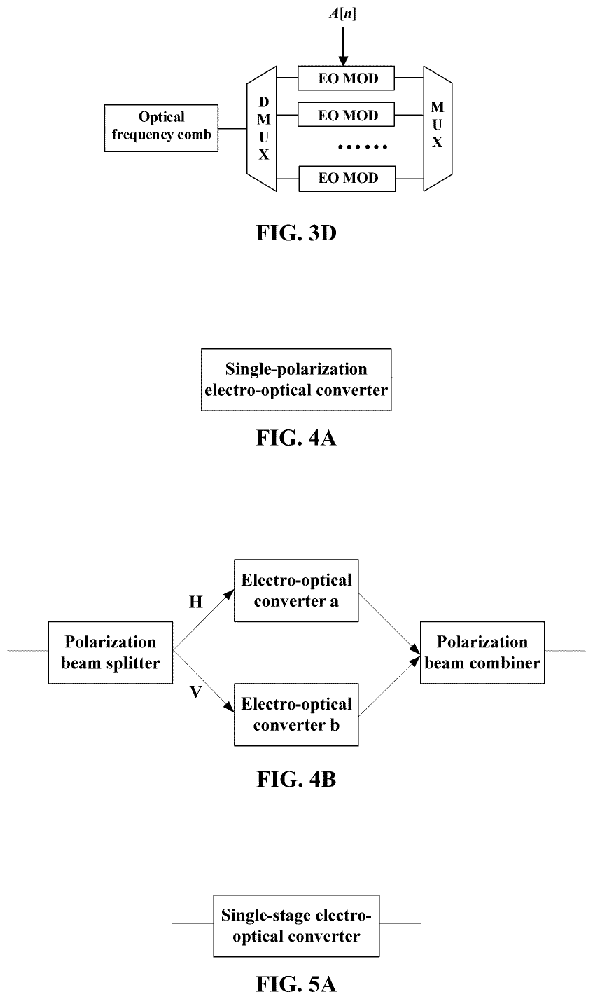

FIG. 3A to FIG. 3D are schematic diagrams of different types of first electro-optical converters in the embodiments of the present disclosure. The first electro-optical converter 201 may be any of the following: a coherent transmitter as shown in FIG. 3A; an intensity modulator as shown in FIG. 3B; a phase modulator as shown in FIG. 3C; a combined signal transmitter based on an optical frequency comb as shown in FIG. 3D.

For another example, the first electro-optical converter 201 may be a transmitter that only outputs a single polarization signal, or may be a transmitter that outputs a dual polarization signal.

FIG. 4A to FIG. 4B are schematic diagrams of first electro-optical converters with different polarization structures in the embodiments of the present disclosure. The first electro-optical converter 201 may be any of the following: a single polarization electro-optical converter as shown in FIG. 4A; a dual polarization electro-optical converter as shown in FIG. 4B.

For another example, the first electro-optical converter 201 may further be based on a single-stage modulation structure, or may be based on a segmented multistage modulation structure, and the segmented design type may be uniformly equal in length (such as a thermometer coded type), or may be of non-equal length (such as a binary coded type).

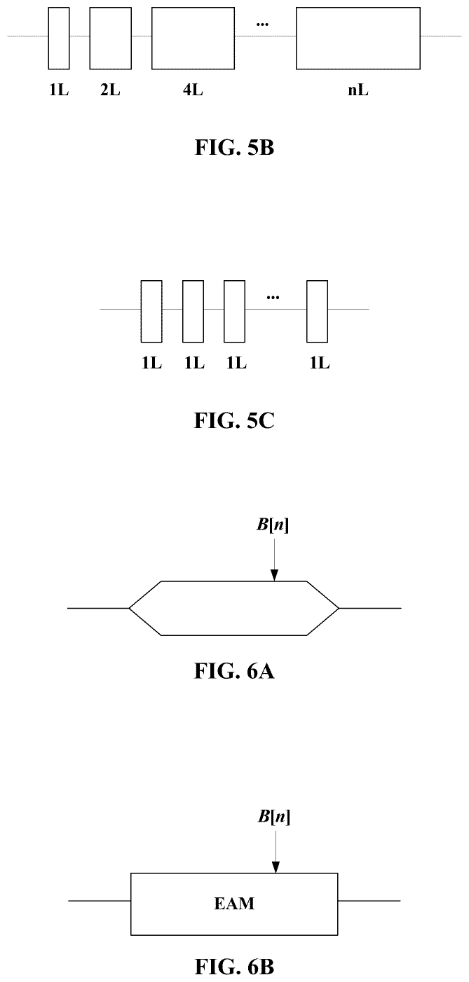

FIG. 5A to FIG. 5C are schematic diagrams of first electro-optical converters with different modulation structures in the embodiments of the present disclosure. The first electro-optical converter 201 may be any of the following: a single-stage electro-optical converter as shown in FIG. 5A; a multistage segmented electro-optical converter with a non-equal-length segmented design structure as shown in FIG. 5B; a multistage segmented electro-optical converter with an equal-length segmented design structure as shown in FIG. 5C.

Assuming that a response of the first electro-optical converter is g(t), a generated optical signal to-be-measured may be simply expressed as E_{S}(t)=ΣₙA[n]g(t−nT), T is a symbol period. The signal to-be-measured A[n] may be a normal communication signal; may further be other test signal designed according to needs, for example when testing an analog characteristic of a branch (I or Q) of a coherent transmitter, a all-zero signal may be transmitted to another branch. Obviously, when A[n] is a normal communication signal, monitoring of an analog characteristic of a transmitter may be carried out (in-service) without affecting transmission of the normal communication signal. When A[n] is a specially designed test signal, the analog characteristic of the transmitter may be monitored before normal communication service begins (pre-service).

As shown in FIG. 2, the second electro-optical converter 202 loads a correlation signal B[n] of a signal to-be-measured onto an optical carrier, generates a modulated local signal and feeds it to the correlation processor 203. Type and structure of the second electro-optical converter 202 also take many forms. For example, it may be an MZ-type intensity modulator (MZM); may be an electrical absorption modulator (EAM); or may be a phase modulator (PM); may further consist of a modulator cascade with L (L≥2) segments having equal or unequal lengths, or is formed by series connection of different types of modulators (such as series connection of MZMs or EAMs and PMs).

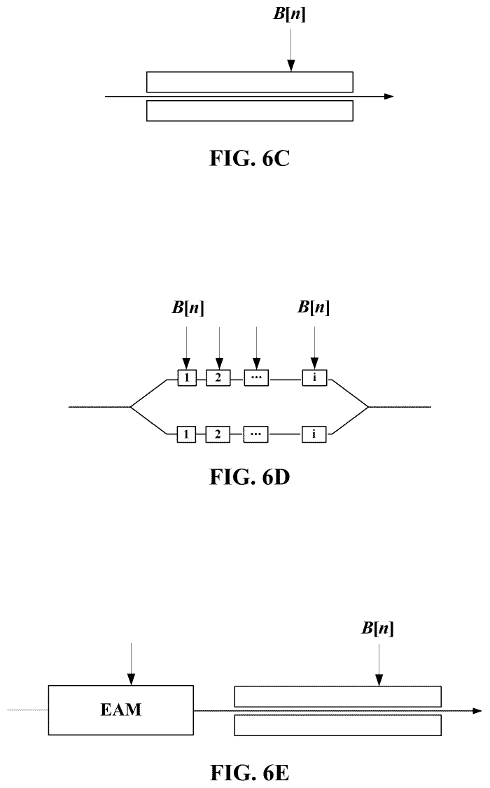

FIG. 6A to FIG. 6E are schematic diagrams of second electro-optical converters with different types and structures in the embodiments of the present disclosure. The second electro-optical converter 202 may be any of the following: the MZ-type intensity modulator with one segment as shown in FIG. 6A; the electrical absorption modulator as shown in FIG. 6B; the phase modulator as shown in FIG. 6C; the MZ intensity modulator with multiple equal-length segments as shown in FIG. 6D; series connection of the electrical absorption modulator and the phase modulator as shown in FIG. 6E. When the second electro-optical converter 202 only has a finite number of states (such as {1, 0, −1}, {1, −1}, {1, 0}), the second electro-optical converter 202 has characteristics of low power consumption and high nonlinear tolerance.

Assuming that a response of the second electro-optical converter 202 is h(t), a generated modulated local signal may be simply expressed as E_{L}(t)=ΣₙB[n]h(t−nT). According to different monitoring target quantities, a correlation signal of a signal to-be-measured may have multiple different selections to generate different modulated local signals.

The first electro-optical converter and the second electro-optical converter are schematically described above, and the second signal and the modulated local signal are described below. For example, the first electro-optical converter shown in FIG. 3A may be taken as an example, for different analog characteristics, specific correlation signal B[n] of a signal to-be-measured and a generated modulated local signal E_{L}(t) are given.

In some implementations, the analog characteristic is frequency-independent IQ imbalance of a coherent transmitter;
the first signal is A[n]=A_{I}[n]+jA_{Q}[n], where A_{I}[n] and A_{Q}[n] respectively represent signals loaded to an I branch and a Q branch of the coherent transmitter;
the second signal is B_{I}¹[n]=A_{I}[n] and B_{Q}¹[n]=A_{Q}[n], B_{I}¹[n] and B_{Q}¹[n] are respectively input to the second electro-optical converter successively, to generate modulated local signals E_{L-I}¹(t)=ΣₙB_{I}¹[n]h(t−nT) and E_{L-Q}¹(t)=ΣₙB_{Q}¹[n]h(t−nT);
or,
the second signal is B_{I}²[n]=A_{I}[n]+A_{I}[n−1]+ . . . +A_{I}[n−k] and B_{Q}²[n]32 A_{Q}[n]+A_{Q}[n−1]+ . . . +A_{Q}[n−k], k=1,2, . . . , K, B_{I}²[n] and B_{Q}²[n] are respectively input to the second electro-optical converter successively, to generate the modulated local signals E_{L-I}²(t)=ΣₙB_{I}²[n]h(t−nT) and E_{L-Q}²(t)=ΣₙB_{Q}²[n]h(t−nT).

In some implementations, the first signal or the second signal may further by quantified by using at least one bit, and a quantized signal is input to the second electro-optical converter to obtain the modulated local signal.

For example, the monitoring target quantity is static IQ imbalance of a coherent transmitter under in-service, such as IQ amplitude imbalance and IQ phase imbalance. “Static” here means that its property is a scalar quantity and is frequency independent. The signal to-be-measured may be represented as A[n]=A_{I}[n]+jA_{Q}[n], where A_{I}[n] and A_{Q}[n] respectively represent a signal loaded to an I branch and a Q branch of a coherent transmitter. In this case, a correlation signal of the signal to-be-measured may be selected to be: B_{I}¹[n]=A_{I}[n] and B_{Q}¹[n]=A_{Q}[n], i.e., B_{I}¹[n] and B_{Q}¹[n] are respectively loaded at twice to the second electro-optical converter, to generate modulated local signals E_{L-1}¹(t)=ΣₙB_{I}¹[n]h(t−nT) and E_{L-Q}¹(t)=ΣₙB_{Q}¹[n]h(t−nT).

For another example, the monitoring target quantity is static IQ imbalance of a coherent transmitter under in-service, such as IQ amplitude imbalance and IQ phase imbalance. “Static” here means that its property is a scalar quantity and is frequency independent. The signal to-be-measured may be represented as A[n]=A_{I}[n]+jA_{Q}[n], where A_{I}[n] and A_{Q}[n] respectively represent a signal loaded to an I branch and a Q branch of a coherent transmitter. In this case, a correlation signal of the signal to-be-measured may be selected to be: B_{I}²[n]=A_{I}[n]+A_{I}[n−1]+ . . . +A_{I}[n−k] and B_{Q}²[n]32 A_{Q}[n]+A_{Q}[n−1]+ . . . +A_{Q}[n−k], k=1,2, . . . , K, in this way, measurement accuracy may be improved. Identically, B_{I}²[n] and B_{Q}²[n] may be respectively loaded at twice to the second electro-optical converter, to generate modulated local signals E_{L-I}²(t)=ΣₙB_{I}²[n]h(t−nT) and E_{L-Q}²(t)=ΣₙB_{Q}²[n]h(t−nT).

For a further example, the monitoring target quantity is static IQ imbalance of a coherent transmitter under in-service, such as IQ amplitude imbalance and IQ phase imbalance. “Static” here means that its property is a scalar quantity and is frequency independent. The signal to-be-measured may be represented as A[n]=A_{I}[n]+jA_{Q}[n], where A_{I}[n] and A_{Q}[n] respectively represent a signal loaded to an I branch and a Q branch of a coherent transmitter. A correlation signal of the signal to-be-measured may further be a signal after quantizing the signal to-be-measured or the correlation signal of the signal to-be-measured by using a finite number of bits, a resulting modulated local signal only has a finite number of states, which can reduce power consumption and hardware cost, and reduce the influence of nonlinearity.

For example, when the signal to-be-measured A[n] is a normal 64 QAM communication signal, values of A_{I}[n] and A_{Q}[n] have 8 different states in total i.e., {−7, −5, −3, −1, 1, 3, 5, 7}. In this case, the correlation signal B_{I/Q}¹[n] of the signal to-be-measured may only have two value taking states, i.e., {−1,1}, represented quantitatively by a bit, i.e., B_{I}¹*[n]=sign(A_{I}[n]) and B_{Q}¹*[n]=sign(A_{Q}[n]), in which sign( ) is a symbol function:

$$\begin{matrix}sign ( x ) = 1 , if x > 0 \\ sign ( x ) = - 1 , if x < 0\end{matrix}$$

Identically, the correlation signal of the signal to-be-measured may further only have four value taking states, i.e., {−3, −1, 1, 3}, represented quantitatively by two bits, i.e., B_{I}¹*[n]=Quan(A_{I}[n]) and B_{Q}¹*[n]=Quan(A_{Q}[n]), in which Quan( ) is a quantization function:

$$\begin{matrix}Quan ( x ) = - 3 , if x = - 7 or - 5 \\ Quan ( x ) = - 1 , if x = - 3 or - 1 \\ Quan ( x ) = 1 , if x = 1 or 3 \\ Quan ( x ) = 3 , if x = 5 or 7\end{matrix}$$

For A[n] with any other modulation format, the above sign(x), Quan(x) or other similar functions may be adopted for performing finite bit quantization to generate a correlation signal of a signal to-be-measured, x may be A_{I/Q}[n], or may be B_{I/Q}¹[n] or B_{I/Q}²[n]. For example, B_{I}²*[n]=sign(B_{I}²[n])=sign(A_{I}[n]+A_{I}[n−1]+ . . . +A_{I}[n−k]) and B_{Q}²*[n]=sign(B_{Q}²[n])=sign(A_{Q}[n]+A_{Q}[n−1]+ . . . +A_{Q}[n−k]), or B_{I}²*[n]=sign(A_{I}[n])+sign(A_{I}[n−1])+ . . . +sign(A_{I}[n−k]) and B_{Q}²*[n]=sign(A_{Q}[n])+sign(A_{Q}[n−1])+ . . . +sign(A_{Q}[n−k]), details are omitted here. For convenience of expression, a modulated local signal generated based on a correlation signal of a signal to-be-measured after quantitative processing is still expressed as E_{L-I/Q}^{1˜2}(t)=ΣₙB_{I/Q}^{1˜2}[n]h(t−nT).

In some implementations, the analog characteristic is IQ skew of a coherent transmitter;
the first signal is A[n]=A_{I}[n]+jA_{Q}[n], where A_{I}[n] and A_{Q}[n] respectively represent signals loaded to an I branch and a Q branch of the coherent transmitter;
the second signal is B_{I}³[n]=A_{I}[n]−A_{I}[n−m] and B_{Q}³[n]=A_{Q}[n]−A_{Q}[n−m], m=1, 2, . . . , M, B_{I}³[n] and B_{Q}³[n] are respectively input to the second electro-optical converter, to generate a modulated local signal

$${E}_{L - I / Q}^{3} ( t - \frac{mT}{2} ) = {\sum }_{n} {B}_{I / Q}^{3} [ n ] h ( t - \frac{mT}{2} - nT ) .$$

For example, the monitoring target quantity is IQ skew of a coherent transmitter under in-service. The signal to-be-measured may be represented as A[n]=A_{I}[n]+jA_{Q}[n], where A_{I}[n] and A_{Q}[n] respectively represent a signal loaded to an I branch and a Q branch of a coherent transmitter. In this case, the correlation signal of the signal to-be-measured may be selected to be: B_{I}³[n]=A_{I}[n]−A_{I}[n−m] and B_{Q}³[n]=A_{Q}[n]−A_{Q}[n−m], m=1, 2, . . . , M, i.e., B_{I}³[n] and B_{Q}³[n] are respectively loaded at twice to the second electro-optical converter, to generate a modulated local signal

$${E}_{L - I / Q}^{3} ( t - \frac{mT}{2} ) = {\sum }_{n} {B}_{I / Q}^{3} [ n ] h ( t - \frac{mT}{2} - nT ) ,$$

in which the semi-symbol periodic delay T/2 is realized by means such as adjusting an electrical delay or a sampling clock phase.

For another example, the monitoring target quantity is IQ skew of a coherent transmitter under in-service. The signal to-be-measured may be represented as A[n]=A_{I}[n]+jA_{Q}[n], where A_{I}[n] and A_{Q}[n] respectively represent a signal loaded to an I branch and a Q branch of a coherent transmitter. A correlation signal of the signal to-be-measured may further be a signal after quantizing the signal to-be-measured or the correlation signal of the signal to-be-measured by using a finite number of bits, a resulting modulated local signal only has a finite number of states, which can reduce power consumption and hardware cost. For example, sign(x), Quan(x) or other similar functions are adopted for performing finite bit quantization to generate a correlation signal B_{I/Q}³[n] of a signal to-be-measured, x may be A_{I/Q}[n] or may be B_{I/Q}³[n], the specific quantification mode is not repeated here. Similarly, the generated modulated local signal may be expressed as E_{L-I/Q}³(t)=ΣₙB_{I/Q}³[n]h(t−nT), m is an even number or

$${E}_{L - I / Q}^{3} ( t - \frac{T}{2} ) = {\sum }_{n} {B}_{I / Q}^{3} [ n ] h ( t - \frac{T}{2} - nT ) ,$$

m is an odd number.

In some implementations, the analog characteristic is frequency-related IQ imbalance of a coherent transmitter;
the first signal is A[n]=A_{I}[n]+jA_{Q}[n], where A_{I}[n] and A_{Q}[n] respectively represent signals loaded to an I branch and a Q branch of the coherent transmitter;
the second signal is B_{I/Q}^{4(q)}[n]=A_{I/Q}[n], B_{I}^{4(q)}[n] and B_{Q}^{4(q)}[n] are respectively input to the second electro-optical converter, to generate a modulated local signal E_{L-I/Q}^{4(q)}(t−(q−1)τ)=ΣₙA_{I/Q}[n]h(t−(q−1)τ−nT), 1≤q≤Y, q is an integer, Y is an empirical value selected according to an analog characteristic of a transmitter to-be-measured, and τ is a unit delay less than T;
or,
when (q−1)τ=mT+δ, 0≤δ<T the second signal is B_{I/Q}^{4(q)}[n]=A_{I/Q}[n−m], B_{I/Q}^{4(q)}[n] and B_{Q}^{4(q)}[n] are respectively input to the second electro-optical converter, to generate a modulated local signal E_{L-I/Q}^{4(q)}(t−(q−1)τ)=ΣₙA_{I/Q}[n−m]h(t−σ−nT).

For example, the monitoring target quantity includes not only static IQ imbalance (IQ amplitude imbalance, IQ phase imbalance and IQ skew) of a coherent transmitter under the aforementioned in-service, but also frequency-dependent IQ imbalance of the coherent transmitter under the in-service, such as a difference in frequency responses of two IQ channels. The signal to-be-measured may be represented as A[n]=A_{I}[n]+jA_{Q}[n], where A_{I}[n] and A_{Q}[n] respectively represent a signal loaded to an I branch and a Q branch of a coherent transmitter. In this case, the modulated local signal is: E_{L-I}^{4(q)}(t−(q−1)τ)=ΣₙB_{I}^{4(q)}[n]h(t−(q−1)τ−nT) and E_{L-Q}^{4(q)}(t−(q−1)τ)=ΣₙB_{Q}^{4(q)}[n]h(t−(q−1)τ−nT), 1≤q≤Y, q is an integer, Y is an empirical value selected according to an analog characteristic of a transmitter to-be-measured, and τ is a unit delay less than T, for example

$$τ = \frac{T}{2} or \frac{T}{4}$$

or others. For each q value, a signal needs to be loaded once, then B_{I}^{4(q)}[n] and B_{Q}^{4(q)}[n] are respectively loaded successively in two batches to the second electro-optical converter. In this case, B_{I/Q}^{4(q)}[n]=A_{I/Q}[n] may be selected, and the delay (q−1)τ is realized only by adjusting an electrical delay, i.e., E_{L-I/Q}^{4(q)}(t−(q−1)τ)=ΣₙA_{I/Q}[n]h(t−(q−1)τ−nT). Moreover, when (q−1)τ=mT+δ, 0≤δ<T, let B_{I/Q}^{4(q)}[n]=A_{I/Q}[n−m], in this case, there is E_{L-I/Q}^{4(q)}(t−(q−1)τ)=ΣₙA_{I/Q}[n−m]h(t−σ−nT), the delay δ is realized by adjusting an electrical delay or a sampling clock phase.

For another example, the monitoring target quantity includes not only static IQ imbalance (IQ amplitude imbalance, IQ phase imbalance and IQ skew) of a coherent transmitter under the aforementioned in-service, but also frequency-dependent IQ imbalance of the coherent transmitter under the in-service, such as a difference in frequency responses of two IQ channels. The signal to-be-measured may be represented as A[n]=A_{I}[n]+jA_{Q}[n], where A_{I}[n] and A_{Q}[n] respectively represent a signal loaded to an I branch and a Q branch of a coherent transmitter. A correlation signal of the signal to-be-measured may further be a signal after quantizing the signal to-be-measured or the correlation signal of the signal to-be-measured by using a finite number of bits.

In some implementations, the analog characteristic is a frequency-independent difference between different segments or between different combinations of segments assigned according to bits within a transmitter;
the first signal is a signal A₍ⱼ₎[n] loaded onto a segment or a combination of segments assigned by a j^{th} bit;
the second signal is B₍ⱼ₎⁵[n]=A₍ⱼ₎[n], B₍ⱼ₎⁵[n] is respectively input to the second electro-optical converter, to generate the modulated local signal E_{L(j)}⁵(t)=ΣₙB₍ⱼ₎⁵[n]h(t−nT);
or,
the second signal is B₍ⱼ₎⁶[n]=A₍ⱼ₎[n]+A₍ⱼ₎[n−1]+ . . . +A₍ⱼ₎[n−k], k=1,2, . . . , K, B₍ⱼ₎⁶[n] is respectively input to the second electro-optical converter, to generate the modulated local signal E_{L(j)}⁶(t)=ΣₙB₍ⱼ₎⁶[n]h(t−nT).

For example, the monitoring target quantity is a static analog characteristic difference (amplitude) between different segments or combinations of segments assigned according to bits within a transmitter under in-service. The signal to-be-measured may be represented as A₍ⱼ₎[n], and is a signal loaded onto a segment or a combination of segments assigned by the j^{th} bit, with a value taking state being {−1,1}, {1,0} or {−1,0}. In this case, a correlation signal of a monitoring signal may be selected as: B₍ⱼ⁵[n]=A₍ⱼ₎[n], B₍ⱼ₎⁵[n] is respectively loaded to the second electro-optical converter successively, to generate the modulated local signal E_{L(j)}⁵(t)=ΣₙB₍ⱼ₎⁵[n]h(t−nT).

For another example, the monitoring target quantity is a static analog characteristic difference (amplitude) between different segments or combinations of segments assigned according to bits within a transmitter under in-service. The signal to-be-measured may be represented as A₍ⱼ₎[n], and is a signal loaded onto a segment or a combination of segments assigned by the j^{th} bit, with a value taking state being {−1,1}, {1,0} or {−1,0}. In this case, a correlation signal of a monitoring signal may be selected as: B₍ⱼ₎⁶[n]=A₍ⱼ₎[n]+A₍ⱼ₎[n−1]+ . . . +A₍ⱼ₎[n−k], k=1,2, . . . , K, which can improve measurement accuracy, and identically, B₍ⱼ₎⁶[n] is respectively loaded to the second electro-optical converter successively, to generate the modulated local signal E_{L(j)}⁶(t)=ΣₙB₍ⱼ₎⁶[n]h(t−nT).

For a further example, the monitoring target quantity is a static analog characteristic difference (amplitude) between different segments or combinations of segments assigned according to bits within a transmitter under in-service. The signal to-be-measured may be represented as A₍ⱼ₎[n], and is a signal loaded onto a segment or a combination of segments assigned by the j^{th} bit, with a value taking state being {−1,1}, {1,0} or {−1,0}. In this case, a correlation signal of the signal to-be-measured may further be a signal after quantizing the signal to-be-measured or the correlation signal of the signal to-be-measured by using a finite number of bits.

In some implementations, the analog characteristic is a skew difference between different segments or between different combinations of segments assigned according to bits within a transmitter;
the first signal is a signal A₍ⱼ₎[n] loaded onto a segment or a combination of segments assigned by a j^{th} bit;
the second signal is B₍ⱼ₎⁷[n]=A₍ⱼ₎[n]−A₍ⱼ₎[n−m], B₍ⱼ₎⁷[n] is respectively input to the second electro-optical converter, to generate the modulated local signal

$${E}_{L ( j )}^{7} ( t - \frac{mT}{2} ) = {\sum }_{n} {B}_{( j )}^{7} [ n ] h ( t - \frac{mT}{2} - nT ) .$$

For example, the monitoring target quantity is a static analog characteristic difference (skew) between different segments or combinations of segments assigned according to bits within a transmitter under in-service. The signal to-be-measured may be represented as A₍ⱼ₎[n], and is a signal loaded onto a segment to-be-measured or a combination of segments assigned by the j^{th} bit, with a value taking state being {−1,1}, {1,0} or {−1,0}. In this case, the correlation signal of the signal to-be-measured may be selected to be: B₍ⱼ₎⁷[n]=A₍ⱼ₎[n]−A₍ⱼ₎[n−m], i.e., B₍ⱼ₎⁷[n] is loaded to the second electro-optical converter successively, a modulated local signal may be expressed as E_{L(j)}⁷(t)=ΣₙB₍ⱼ₎⁷[n]h(t−nT), m is an even number, or

$${E}_{L ( j )}^{7} ( t - \frac{T}{2} ) = {\sum }_{n} {B}_{( j )}^{7} [ n ] h ( t - \frac{T}{2} - nT ) ,$$

m is an odd number, the semi-symbol periodic delay T/2 is realized by means such as adjusting an electrical delay or a sampling clock phase.

For another example, the monitoring target quantity is a static analog characteristic difference (skew) between different segments or combinations of segments assigned according to bits within a transmitter under in-service. The signal to-be-measured may be represented as A₍ⱼ₎[n], and is a signal loaded onto a segment to-be-measured or a combination of segments assigned by the j^{th} bit, with a value taking state being {−1,1}, {1,0} or {−1,0}. In this case, a correlation signal of the signal to-be-measured may further be a signal after quantizing the signal to-be-measured or the correlation signal of the signal to-be-measured by using a finite number of bits.

In some implementations, the analog characteristic is a frequency-related difference between different segments or between different combinations of segments assigned according to bits within a transmitter;
the first signal is a signal A₍ⱼ₎[n] loaded onto a segment or a combination of segments assigned by a j^{th} bit;
the second signal is B₍ⱼ₎^{8(q)}=A₍ⱼ₎[n], B₍ⱼ₎^{8(q)} is respectively input to the second electro-optical converter, to generate the modulated local signal E_{L(j)}^{8(q)}(t−(q−1)τ)=ΣₙA₍ⱼ₎[n]h(t−(q−1)τ−nT), 1≤q≤Y, q is an integer, Y is an empirical value selected according to an analog characteristic of a transmitter to-be-measured, and τ is a unit delay less than T;
or,
when (q−1)τ=mT+δ, 0≤δ<T, the second signal is B₍ⱼ₎^{8(q)}=A₍ⱼ₎[n−m], B₍ⱼ₎^{8(q)} is respectively input to the second electro-optical converter, to generate the modulated local signal E_{L(j)}^{8(q)}(t−(q−1)τ)=ΣₙA₍ⱼ₎[n−m]h(t−δ−nT).

For example, the monitoring target quantity includes not only a static analog characteristic difference (amplitude and phase imbalance, skew) between different segments or combinations of segments assigned according to bits within a transmitter under in-service, but also a frequency-related difference, such as a frequency response difference between different segments or combinations of segments assigned according to bits. The signal to-be-measured may be represented as A₍ⱼ)[n], and is a signal loaded onto a segment to-be-measured or a combination of segments assigned by the j^{th} bit, with a value taking state being {−1,1}, {1,0} or {−1,0}. In this case, the modulated local signal is: E_{L(j)}^{8(q)}(t−(q−1)τ)=ΣₙB₍ⱼ₎^{8(q)}[n]h(t−(q−1)τ−nT), 1≤q≤Y, q is an integer, Y is an empirical value selected according to an analog characteristic of a transmitter to-be-measured, and τ is a unit delay less than T,

$$τ = \frac{T}{2} or \frac{T}{4}$$

or others. For each q value, a signal needs to be loaded once, then B₍ⱼ₎^{8(q)} is respectively loaded in multiple batches to the second electro-optical converter. If the transmitter contains J bits in total, the number of batches will also be J. In this case, B₍ⱼ₎^{8(q)}=A₍ⱼ₎[n] may be selected, and the delay (q−1)τ is realized only by adjusting an electrical delay, i.e., E_{L(j)}^{8(q)}(t−(q−1)τ)=ΣₙA₍ⱼ₎[n]h(t−(q−1)τ−nT). Moreover, when (q−1)τ=mT+δ, 0≤δ<T, B₍ⱼ₎^{8(q)}=A₍ⱼ₎(h)[n−m] may further be selected, in this case, there is E_{L(j)}^{8(q)}(t−(q−1)τ)=ΣₙA₍ⱼ₎[n−m]h(t−δ−nT), δ is realized by adjusting an electrical delay or a sampling clock phase.

For another example, the monitoring target quantity includes not only a static analog characteristic difference (amplitude and phase imbalance, skew) between different segments or combinations of segments assigned according to bits within a transmitter under in-service, but also a frequency-related difference, such as a frequency response difference between different segments or combinations of segments assigned according to bits. The signal to-be-measured may be represented as A₍ⱼ₎[n], and is a signal loaded onto a segment to-be-measured or a combination of segments assigned by the j^{th} bit, with a value taking state being {−1,1}, {1,0} or {−1,0}. In this case, a correlation signal of the signal to-be-measured may further be a signal after quantizing the signal to-be-measured or the correlation signal of the signal to-be-measured by using a finite number of bits.

In some implementations, the analog characteristic is a difference between different polarization states as a whole within a dual polarization transmitter or a difference between different segments or between different combinations of segments assigned according to bits in different polarization states within a dual polarization transmitter;

H and V respectively represent an H polarization state and a V polarization state of the dual polarization transmitter, and second signals of H branch and V branch of the dual polarization transmitter are B_{H}⁹[n] and B_{V}⁹[n] respectively.

For example, the monitoring target is an analog characteristic difference between different polarization states as a whole within a dual polarization transmitter under in-service or an analog characteristic difference (amplitude, skew or frequency response difference) between different segments or between different combinations of segments assigned according to bits in different polarization states within a dual polarization transmitter under in-service, appropriate correlation signal B^{1˜8}[n] of the above signal to-be-measured may be selected according to the above-mentioned processing mode, and these signals may be uniformly denoted as B_{H/V}⁹[n] to generate a corresponding modulated local signal E_{L-H/V}⁹(t), which will not be described in details here. H and V respectively represent an H polarization state and a V polarization state of the dual polarization transmitter, i.e., B_{H}⁹[n] and B_{V}⁹[n] are selected respectively according to signals to-be-measured on the H branch and V branch of the dual polarization transmitter.

In some implementations, the analog characteristic is an analog characteristic of the first electro-optical converter under a specific symbol or a specific symbol sequence; the first signal is expressed as A[n], the second signal B¹⁰[n] is a constant when corresponding to the specific symbol, or, the second signal B¹¹[n] is a constant when corresponding to a central symbol of the specific symbol sequence, and the modulated local signal is a pulse signal.

For example, the monitoring target quantity is an analog characteristic of the first electro-optical converter under a specific symbol or a specific symbol sequence under in-service (for example, for a coherent transmitter, any one separate I or Q branch is taken into account; for a dual polarization intensity modulation transmitter, any one polarization state branch is taken into account; for a dual polarization coherent transmitter, any one single separate I or Q branch in any one of its polarization states is taken into account). For example, assuming that the signal to-be-measured A[n] in this case is a PAM8 signal, each symbol in A[n] is a random one in {−7, −5, −3,−1, 1, 3, 5, 7}. In this case, an appropriate correlation signal of the signal to-be-measured may be selected so that a generated modulated local signal is a pulse signal. For example, when the monitoring target quantity is an analog characteristic of the first electro-optical converter under the input symbol [−3], the signal to-be-measured may be selected as B¹⁰[n], specifically

$${B}^{10} [ n ] = C if A [ n ] = - 3$$

$${B}^{10} [ n ] = 0 if A [ n ] \neq - 3$$

where, C is a constant, may be 1 or some other non-zero constant. For any other specific symbol, by analogy, more detailed description is omitted here. The generated modulated local signal is denoted as E_{L}¹⁰(t).

For another example, the monitoring target quantity is an analog characteristic of the first electro-optical converter under the input symbol sequence[7 1 5], the signal to-be-measured may be selected as B¹¹[n], specifically

$${B}^{11} [ n ] = C if A [ n - 1 ] = 7 and A [ n ] = 1 and A [ n + 1 ] = 5$$

$${B}^{11} [ n ] = 0 if A [ n - 1 ] \neq 7 or A [ n ] \neq 1 or A [ n + 1 ] \neq 5$$

Identically, where, C is a constant, may be 1 or some other non-zero constant. For any other specific symbol sequence whose length is 3 or longer, by analogy, more detailed description is omitted here. The generated modulated local signal is denoted as E_{L}¹¹(t).

It should be noted that the correlation signal B^{1˜11}[n] of the signal to-be-measured does not need to be loaded in real time, that is, T₂ is opened and lasted by passing an interval of time T₁, i.e.,

$${B}^{1 \sim 11} [ n ] = 0 if m ( {T}_{1} + {T}_{2} ) \leq t < m ( {T}_{1} + {T}_{2} ) + {T}_{1} , m = 0 , 1 , 2 , …$$

$${B}^{1 \sim 11} [ n ] = {B}^{1 \sim 11} [ n ] if m ( {T}_{1} + {T}_{2} ) + {T}_{1} \leq t < ( m + 1 ) ( {T}_{1} + {T}_{2} ) , m = 0 , 1 , 2 , …$$

In this way, the overall monitoring power consumption may be reduced.

For another example, the monitoring target quantity is the above-mentioned various to-be-measured target quantities in a transmitter under pre-service, and the signal to-be-measured may be a specially designed testing signal whose value taking states is unlimited. For example, for a coherent transmitter, if I-branch analog characteristic is tested, let A_{Q}[n]=0; for a modulator with a segment cascade structure, if an analog characteristic of a segment or a combination of segments assigned by the z^{th} bit is tested, let A₍ⱼ₎[n]=0, j≠z, so as to completely avoid interference introduced by a non-measured segment or combination of segments. The correlation signal of the signal to-be-measured may still be selected by adopting the above signal B^{1˜11}[n], which is not described in details here.

In some implementations, the analog characteristic is static and dynamic analog characteristics of each segment within a transmitter with a multi-segment modulator cascaded structure;
a first signal of an segment to-be-measured is A₍ₛ₎[n], and a first signal of a not-to-be measured segment is A_{(w)}[n]=0, w≠s;
the second signal is B₍ₛ₎^{12(q)}=A₍ₛ₎[n], B₍ₛ₎^{12(q)} respectively input to the second electro-optical converter, to generate the modulated local signal E_{L(s)}^{12(q)}(t−(q−1)τ)=ΣₙA₍ₛ₎[n]h(t−(q−1)τ−nT), 1≤q≤Y, 1≤q≤Y, q is an integer, and τ is a unit delay less than T;
or,
when (q−1)τ=mT+δ, 0≤δ<T, the second signal is B₍ₛ₎^{12(q)}=A₍ₛ₎[n−m], B₍ₛ₎^{12(q)} is respectively input to the second electro-optical converter, to generate the modulated local signal E_{L(s)}^{12(q)}(t−(q−1)τ)=ΣₙA₍ₛ₎[n−m]h(t−δ−nT).

For example, the monitoring target is static and dynamic analog characteristics of each segment in a transmitter with a multi-segment modulator cascade structure, and all segments may be tested one by one at a pre-service phase. For example, when the to-be-tested object is an s^{th} segment, in this case, a test signal may be expressed as A_{(w)}[n]=0, w≠s, i.e., all other non-to-be-tested segments transmit a zero signal or are closed and do not work, and the test signal A₍ₛ₎[n] on a to-be-tested segment is an arbitrary random signal with a good auto-correlation characteristic. In this case, the modulated local signal is: E_{L(s)}^{12(q)}(t−(q−1)τ)=ΣₙB₍ₛ₎^{12(q)}[n]h(t−(q−1)τ−nT), 1≤q≤Y, q is an integer, and τ is a unit delay less than T,

$$τ = \frac{T}{2} or \frac{T}{4}$$

or others. For each q value, a signal needs to be loaded once, then B₍ₛ₎^{12(q)} is respectively loaded in multiple batches to the second electro-optical converter. If the transmitter contains S segments in total, the number of batches will also be S. In this case, B₍ₛ₎^{12(q)}=A₍ₛ₎[n] may be selected, and the delay (q−1)τ is realized only by adjusting an electrical delay, i.e., E_{L(s)}^{12(q)}(t−(q−1)τ)=ΣₙA₍ₛ₎[n]h(t−(q−1)τ−nT). Moreover, when (q−1)τ=mT+δ,0≤δ<T, B₍ₛ₎^{12(q)}=A₍ₛ₎[n−m] may further be selected, in this case, there is E_{L(s)}^{12(q)}(t−(q−1)τ)=ΣₙA₍ₛ₎[n−m]h(t−δ−nT), δ is realized by adjusting an electrical delay or a sampling clock phase.

The above text schematically describes the second signal and the modulated local signal,

and a correlation processor is described below by returning to FIG. 2.

As shown in FIG. 2, a correlation processor 203 performs correlation processing on the optical signal to-be-measured E_{S}(t) output by the first electro-optical converter 201 and the modulated local signal E_{L}(t) output by the second electro-optical converter 202 based on low-speed photoelectric and electrical devices, to obtain correlation quantity of the two signals:

$$\frac{\int {E}_{S} ( t ) {E}_{L} ( t ) dt}{\int dt} = \frac{\int {\sum }_{n} A [ n ] g ( t - nT ) {\sum }_{m} B [ m ] h ( t - mT ) dt}{\int dt}$$

There are many modes to implement a correlation processing operation based on parallel modulation. The first electro-optical converter in FIGS. 3, 4 and 5 and the second electro-optical converter in FIG. 6 are taken as examples below to illustrate specific implementations for different target monitoring quantities. When the monitoring target quantity is an analog characteristic of a transmitter under in-service, the correlation processor may have the following implementations.

In some implementations, the first electro-optical converter is a coherent transmitter.

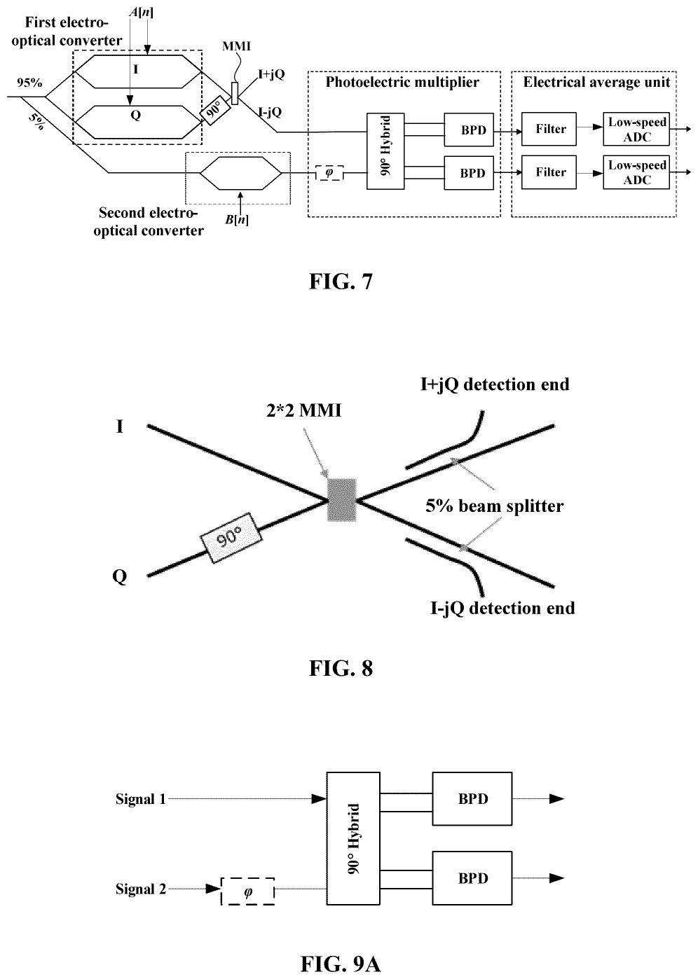

FIG. 7 is a schematic diagram of correlation processing in the embodiments of the present disclosure, showing a situation in which when the first electro-optical converter is a coherent transmitter, it is used to monitor correlation processing of IQ imbalance of the coherent transmitter. As shown in FIG. 7, part of direct current light is delivered to the second electro-optical converter before the modulator. The correlation processor is implemented based on a photoelectric multiplier and an electrical average unit.

As shown in FIG. 7, the photoelectric multiplier includes an optional phase shifter (i.e., φ is optional), a 90° optical mixer, and a balanced photodetector (BPD); the electrical average unit includes a low-pass filter and a low-speed ADC, and an electrical average operation may be implemented in an analog domain or a digital domain. When the electrical average operation is implemented in the analog domain, the low-speed ADC outputs monitoring voltage average values <V₁(t)> and <V₂(t)>. When the electrical average operation is implemented in the digital domain, the low-speed ADC outputs monitoring voltage signals V₁(t) and V₂(t), then <V₁(t)> and <V₂(t)> are obtained by means of digital averaging.

An output optical signal of the coherent transmitter is denoted as E_{S}(t)=E_{S-I}(t)+jE_{S-Q}(t), an output signal of the second photoelectric converter is denoted as E_{L}(t), and a phase difference between them is denoted as φ. After an ideal 90-degree frequency mixer, an output optical signal may be denoted as:

$$\frac{1}{2} [ \begin{matrix}{E}_{S} ( t ) - {E}_{L} ( t ) {e}^{j φ} \\ j ( {E}_{S} ( t ) + {E}_{L} ( t ) {e}^{j φ} ) \\ j ( {E}_{S} ( t ) + {jE}_{L} ( t ) {e}^{j φ} ) \\ - ( {E}_{S} ( t ) - {jE}_{L} ( t ) {e}^{j φ} )\end{matrix} ]$$

Subsequently, a balanced photodetector (BPD) output current may be expressed as

$$\begin{matrix}{I}_{BPD 1} ( t ) = \frac{{R}_{BPD}}{4} ( {\vert {E}_{S} ( t ) + {E}_{L} ( t ) {e}^{j φ} \vert}^{2} - {\vert {E}_{S} ( t ) - {E}_{L} ( t ) {e}^{j φ} \vert}^{2} ) \\ = {R}_{BPD} [ {E}_{s} ( t ) {E}_{L}^{*} ( t ) {e}^{- j φ} + {E}_{s}^{*} ( t ) {E}_{L} ( t ) {e}^{j φ} ] / 2 \\ {I}_{BPD 2} ( t ) = \frac{{R}_{BPD}}{4} ( {\vert {E}_{S} ( t ) + {jE}_{L} ( t ) {e}^{j φ} \vert}^{2} - {\vert {E}_{S} ( t ) - {jE}_{L} ( t ) {e}^{j φ} \vert}^{2} ) \\ = {R}_{BPD} [ - {jE}_{s} ( t ) {E}_{L}^{*} ( t ) {e}^{- j φ} + {jE}_{s}^{*} ( t ) {E}_{L} ( t ) {e}^{j φ} ] / 2 \\ = {R}_{BPD} [ {E}_{s} ( t ) {E}_{L}^{*} ( t ) {e}^{- j ( φ + π / 2 )} + {E}_{s}^{*} ( t ) {E}_{L} ( t ) {e}^{j ( φ + π / 2 )} ] / 2\end{matrix}$$

where, R_{BPD} represents a response of the balanced photodetector, and φ represents a constant phase. When E_{L}(t)=E_{L-I}(t)=ΣₙB_{I}[n]h(t−nT), E_{L}(t) is correlated with Aᵢ[n], i.e., is correlated with E_{S-I}(t), I_{BPD1}(t) and I_{BPD2}(t) output by the photoelectric multiplier contain information of E_{L}(t)E_{S-I}(t), correlation V₁^{I} and V₂^{I} of two signals may be obtained through the electrical average unit; similarly, when E_{L}(t)=E_{L-Q}(t), correlation V₁^{Q} and V₂^{Q} of the two signals may be obtained. When E_{L}(t) is a signal E_{L}(t−(q−1)τ) after delay, obtained correlation may further be denoted as V₁^{I/Q}[q] and V₂^{I/Q}[q]. For different modulated local signals, corresponding correlation quantity may be obtained respectively by using this method.

It should be noted that the embodiment shown in FIG. 7 is just a framework example, and specific details of each unit may be different.

FIG. 8 shows a possible output port of a first electro-optical converter in the embodiments of the present disclosure. For example, the output signal of the first electro-optical converter in FIG. 7 is a signal I−JQ at another branch output side of the 2*2 multi-mode interference (MMI) coupler, or may be a normal output signal I+jQ of the transmitter shown in FIG. 8, or an output of its monitoring branch.

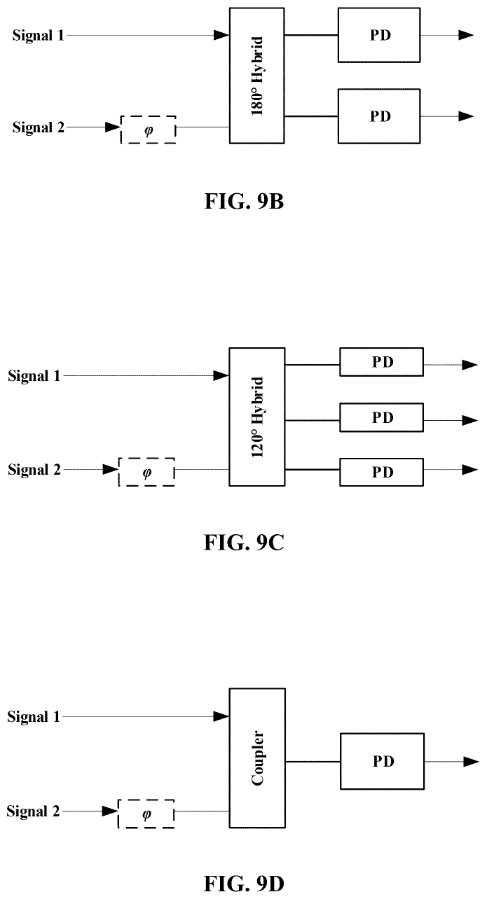

FIG. 9A to FIG. 9D are schematic diagrams of a photoelectric multiplier in the embodiments of the present disclosure. The photoelectric multiplier may be implemented in a variety of modes, as shown in FIG. 9A, using an optional phase shifter, a 90-degree hybrid and two balanced photodetectors; as shown in FIG. 9B, adopting a phase shifter, a 180-degree hybrid and two single photodetectors; as shown in FIG. 9C, adopting an optional phase shifter, a 120 degree hybrid and 3 single photodetectors; as shown in FIG. 9D, adopting a phase shifter, a coupler and a single photodetector.

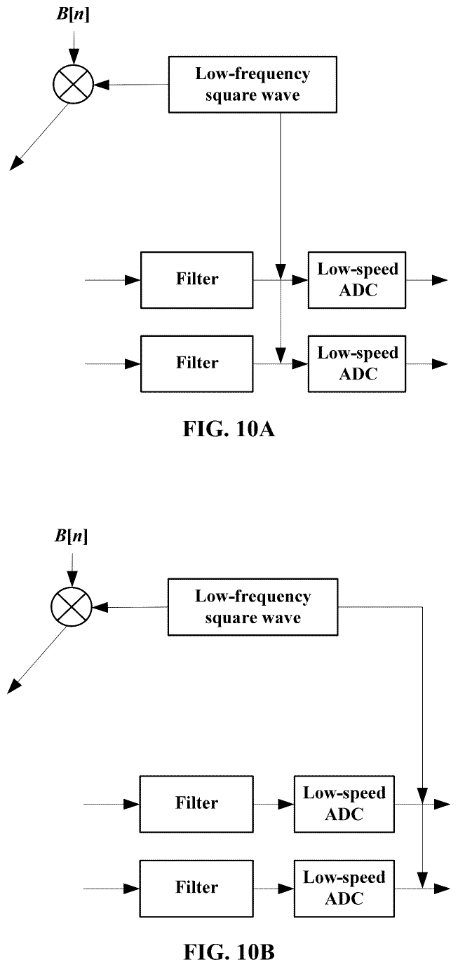

FIG. 10A and FIG. 10B are schematic diagrams of an electrical average unit added with a function of multiplying a square wave with a frequency shift in the embodiments of the present disclosure. An electrical average operation may be realized in an analog domain or a digital domain. For example, a sampled signal is mathematically averaged through a low-pass filter or a low-speed ADC. In addition, multiplying a square wave with a frequency shift may further be introduced, and a 125 MHz square wave may be multiplied simultaneously on a correlation signal of a signal to-be-measured and a product signal. Accordingly, a correlation quantity may be transferred from DC to a 125 MHz-frequency position, thus avoiding 1/f noise near DC. As shown in FIG. 10A, multiplication with the product signal may be carried out in an analog domain, and as shown in FIG. 10B, may be carried out in a digital domain, embodiments of the present disclosure do not impose specific limitations in this regard.

In some implementations, the first electro-optical converter is a segment or a combination of segments assigned by bit within a coherent transmitter. The second electro-optical converter is an independent electro-optical converter shown in FIG. 6, in this case, for implementations of correlation processing, the embodiment shown in FIG. 7 may still be adopted.

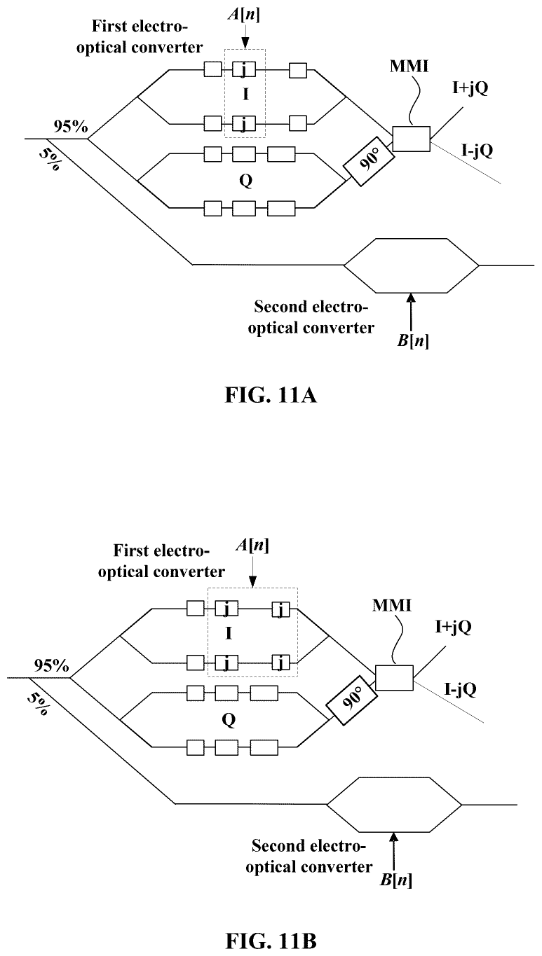

FIG. 11A and FIG. 11B are schematic diagrams of a first electro-optical converter and a second electro-optical converter in the embodiments of the present disclosure, showing a relationship between the first electro-optical converter and the second electro-optical converter when the first electro-optical converter is a certain segment (as shown in FIG. 11A) or a combination of segments (as shown in FIG. 11B) assigned by bit in a coherent transmitter. In this case, for implementations of the photoelectric multiplier, refer to FIG. 9. Obtained correlation is denoted as V₁^{j}[q] and V₂^{j}[q], j represents a segment or combination of segments assigned by the jth to-be-measured bit. For different modulated local signals, correlation quantity may be obtained by using this method.

In some implementations, the first electro-optical converter is a segment or a combination of segments assigned by bit in a MZM intensity modulator or inside thereof. The second electro-optical converter is an independent electro-optical converter shown in FIG. 6.

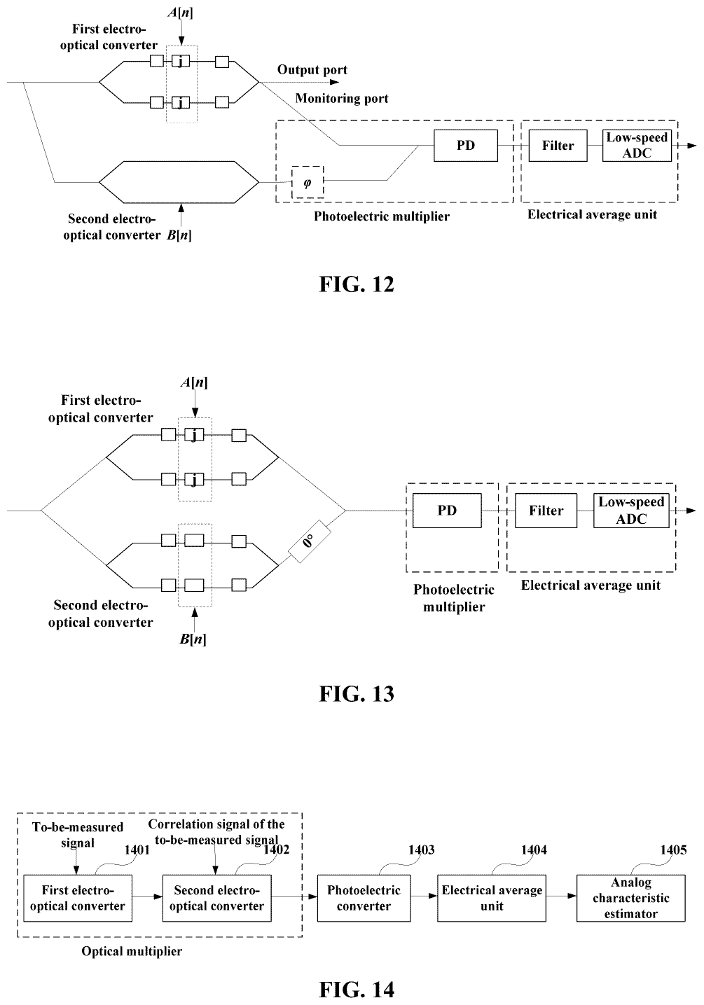

FIG. 12 is a schematic diagram of a first electro-optical converter and a second electro-optical converter in the embodiments of the present disclosure, showing that the first electro-optical converter is a certain segment or a combination of segments assigned by bit in an MZM intensity modulator or inside thereof, and the second electro-optical converter is an independent electro-optical converter. As shown in FIG. 12, the photoelectric multiplier consists of a single photodetector. For different modulated local signals, correlation quantity may be obtained by using this mode. j therein represents a segment or combination of segments assigned by the jth to-be-measured bit.

In some implementations, the first electro-optical converter is a dual polarization transmitter, and the second electro-optical converter is an independent electro-optical converter shown in FIG. 6. Overall analog characteristic of different polarization states may be monitored according to the above embodiments; when the first electro-optical converter is a different segment or combination of segments assigned by bit in each polarization state of a dual polarization transmitter, and the second electro-optical converter is an independent electro-optical converter as shown in FIG. 6, each polarization state may be monitored according to the above embodiments. For obtaining correlation quantity for different modulated local signals, no more detailed description is provided here.

When the monitoring target quantity is an analog characteristic of a transmitter under pre-service, the above implementations may be adopted to perform correlation processing on a modulated local signal and a signal to-be-measured. The present disclosure is not limited to the above implementations, the following modes may further be adopted.

FIG. 13 is a schematic diagram of a first electro-optical converter and a second electro-optical converter in the embodiments of the present disclosure, the first electro-optical converter is any certain segment or combination of segments in a coherent transmitter, and the second electro-optical converter is a certain segment or combination of segments or an entire parallel branch parallel to the first electro-optical converter, in the coherent transmitter. A difference from a typical coherent transmitter configuration lies that a phase difference between I branch and Q branch is 0 degree, so that correlation processing of the first electro-optical converter and the second electro-optical converter as shown in FIG. 2 may be realized. In this case, the photoelectric multiplier may be only composed of a single photodetector, and then a correlation V^{j}[q] may be obtained via an electrical average operation. For different modulated local signals, correlation may be obtained by using this method, no more detailed description is provided here.

The above text schematically describes the correlation processor, and the analog characteristic estimator 204 is described below by returning to FIG. 2. The analog characteristic estimator 204 may estimate corresponding target monitoring quantities according to all the above correlation quantities.

For example,
i) For V₁^{i-I/Q}|_{i=1˜2} and V₂^{i-I/Q}|_{i=1˜2}, IQ amplitude imbalance may be calculated as:

$$AmpImb = \sqrt{\frac{( {( {V}_{1}^{i - I} )}^{2} + {( {V}_{2}^{i - I} )}^{2} )}{( {( {V}_{1}^{i - Q} )}^{2} + {( {V}_{2}^{i - Q} )}^{2} )}} , i = 1 , 2$$

phase imbalance is:

$$PhaseImb = arcsin ( {V}_{1}^{i - I} * {V}_{1}^{i - Q} + {V}_{2}^{i - I} * {V}_{2}^{i - Q} ) , i = 1 , 2$$

ii) For V₁^{i-I/Q}|ᵢ₌₃ and V₂^{i-I/Q}|ᵢ₌₃, IQ skew=C₁(V₁^{i-I}−V₁^{i-Q})=C₂(V₂ⁱ⁻¹−V₂^{i-Q}), C₁ and C₂ may be determined by pre-calibration in a pre-service phase.
iii) For V₁^{i-I/Q}[q]|ᵢ₌₄ and V₂^{i-I/Q}[q]|ᵢ₌₄, a matrix

$$[ \begin{matrix}{V}_{1}^{i - I} [ q ] & {V}_{1}^{i - Q} [ q ] \\ {V}_{2}^{i - I} [ q ] & {V}_{2}^{i - Q} [ q ]\end{matrix} ] = [ \begin{matrix}{h}_{II} [ q ] & {h}_{IQ} [ q ] \\ {h}_{QI} [ q ] & {h}_{QQ} [ q ]\end{matrix} ]$$

directly indicates a transfer function of a to-be-tested transmitter, and may directly calculate IQ amplitude imbalance, IQ phase imbalance, IQ skew, and frequency-dependent imbalance between IQs according to a related art.

For V₁^{i-j}|_{i=5˜7} and V₂^{i-j}|_{i=5˜7} and V₁^{i-j}[q]|ᵢ₌₈ and V₂^{i-j}[q]|ᵢ₌₈, a corresponding analog characteristic difference between segments or a combination of segments may be calculated by referring to i), ii) and iii), no more detailed description is provided here.

For correlation quantity V_{1/2}^{i-I/Q}|_{i=1˜3}, V_{1/2}^{i-I/Q}[q]|ᵢ₌₄, V_{1/2}^{i-j}|_{i=5˜7} and V_{1/2}^{i-j}[q]|ᵢ₌₈ obtained by a correlation signal of a signal to-be-measured obtained after performing quantization processing using a finite number of bits, a corresponding analog characteristic difference may also be calculated by referring to i), ii) and iii), no more detailed description is provided here.

For V₁^{9-H}[q], V₂^{9-H}[q], V₁^{9-V}[q]and V₂^{9-V}[q]or V^{9-H}[q] and V^{9-V}[q], imbalance between corresponding polarization states or imbalance between different segments in a polarization state may also be calculated by referring to the above contents.

For Vⁱ|_{i=10˜11}, it per se directly indicates an analog characteristic of a first electro-optical converter to-be-measured under a specific symbol or a specific symbol sequence.

For Vⁱ[q]|ᵢ₌₁₂, it per se indicates an analog characteristic of a to-be-tested segment or combination of segments.

Parallel modulation is schematically described above by taking FIG. 2 as an example, and series modulation is described below.

In some embodiments, the first electro-optical converter and the second electro-optical converter are connected in series; the first electro-optical converter generates the optical signal to-be-measured based on an optical carrier and the first signal, and the second electro-optical converter generates the modulated local signal based on the optical signal to-be-measured and the second signal; the modulated local signal is input to a photoelectric converter to obtain an electrical signal; and the electrical signal generates the at least one correlation quantity after being electrically averaged.

FIG. 14 is a schematic diagram of an apparatus for monitoring an analog characteristic of a transmitter based on series modulation correlation processing, in the embodiments of the present disclosure. As shown in FIG. 14, the apparatus may include:
a first electro-optical converter 1401, which is an optical transmitter per se or only a part of the optical transmitter, whose analog characteristic is a target quantity to be monitored, the first electro-optical converter 1401 generating an optical signal to-be-measured;
a second electro-optical converter 1402, which generates an optical product signal according to a correlation signal of the signal to-be-measured, and realizes product calculation of the optical signal to-be-measured and the correlation signal of the signal to-be-measured in an optical domain;
a photoelectric converter 1403, which converts an optical product signal into an electrical signal;
an electrical average unit 1404, which performs electrical averaging on an electrical signal output by the photoelectric converter to obtain correlation quantity between the signal to-be-measured and the correlation signal of the signal to-be-measured; and
an analog characteristic estimator 1405, which estimates an analog characteristic of the first electro-optical converter according to the correlation quantity of the signals.

It is worth noting that FIG. 14 exemplarily describes structures for implementing monitoring of an analog characteristic of an optical transmitter, however the present disclosure is not limited to these structures, these structures may further be modified appropriately, and implementations of such modifications should be included within the scope of the embodiments of the present disclosure.

As shown in FIG. 14, the first electro-optical converter 1401 generates an optical signal to-be-measured corresponding to the signal to-be-measured A[n] through modulation and inputs it to the second electro-optical converter 1402 The first electro-optical converter 1401 may be a complete optical transmitter or may be only a part of the optical transmitter. It should be noted that the embodiments of the present disclosure do not impose any restrictions on a type and structure of the first electro-optical converter 1401. For example, it may have changes shown in FIGS. 3, 4, and 5, or it may be a directly modulated laser.

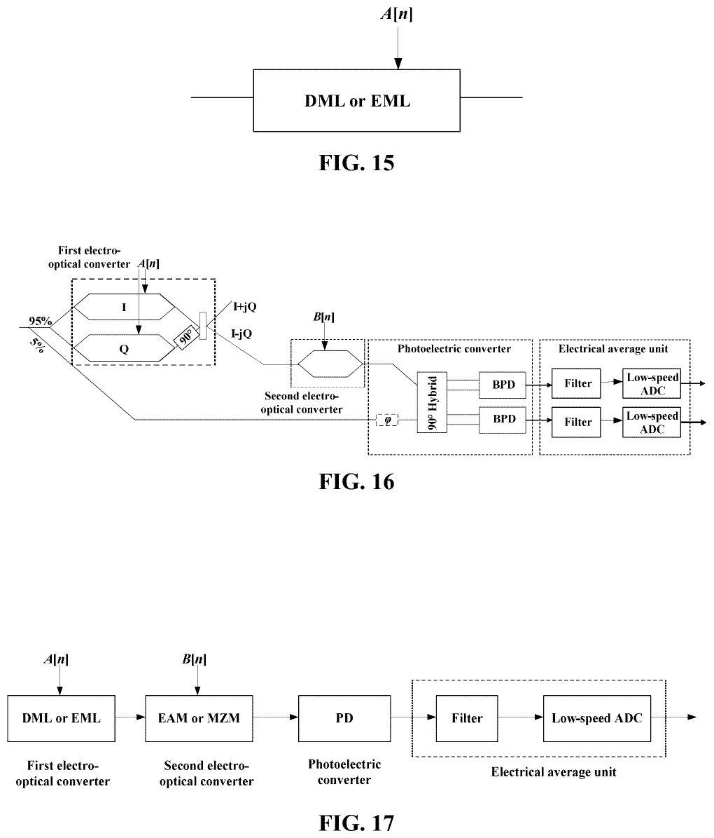

FIG. 15 is a schematic diagram of a first electro-optical converter in the embodiments of the present disclosure. As shown in FIG. 15, the first electro-optical converter may be a directly modulated laser (DML or EML).

Assuming that a response of the first electro-optical converter is g(t), a generated optical signal to-be-measured may be expressed as E_{S}(t)=ΣₙA[n]g(t−nT). The signal to-be-measured A[n] may be a normal communication signal, may further be other test signal designed according to needs, for example when testing an analog characteristic of a branch (I or Q) of a coherent transmitter, an all-zero signal may be transmitted to another branch. Obviously, when A[n] is a normal communication signal, monitoring of an analog characteristic of a transmitter may be carried out (in-service) without affecting transmission of the normal communication signal; when A[n] is a specially designed test signal, the analog characteristic of the transmitter may be monitored before normal communication service begins (pre-service).

As shown in FIG. 14, the second electro-optical converter 1402 loads the correlation signal B[n] of the signal to-be-measured onto an optical signal to-be-measured to generate an optical product signal, that is, the product calculation of the optical signal to-be-measured and the correlation signal of the signal to-be-measured is directly completed in an optical domain by means of series modulation. Series modulation is a natural product operation. The optical product signal in essence may still be regarded as a modulated local signal.

Type and structure of the second electro-optical converter 1402 also have many forms, and may have variations as shown in FIG. 6. Meanwhile, according to different monitoring target quantities, the correlation signal B[n] of the signal to-be-measured may have multiple different selections to generate different optical product signals, the embodiments of the present disclosure does not make specific constraints in the regard either.

It should be noted that all the monitoring target quantities mentioned in parallel modulation correlation processing and a corresponding correlation signal B^{1˜12}[n] of a signal to-be-measured are applicable here. A difference is that in this case, the output signal of the second electro-optical converter is an optical product signal E_{M}^{1˜12}=E_{S}(t)ΣₙB^{1˜12}[n]h(t−nT), h(t) still represents a response of the second electro-optical converter.

As shown in FIG. 14, the photoelectric converter 1403 converts the optical product signal into an electrical signal, and there are multiple series modulation and photoelectric conversion (detection) modes according to different monitoring target quantities.

FIG. 16 is a schematic diagram of series-based modulation and coherent detection in the embodiments of the present disclosure. As shown in FIG. 16, the photoelectric converter includes an optional phase shifter (“optional” indicates it may have or may not have), a 90-degree frequency mixer, and a balanced photodetector, and converts an optical domain product signal into an electrical signal. It should be noted that FIG. 16 exemplarily shows a framing example, the photoelectric converter may further have the variation shown in FIG. 9.

When the monitoring target quantity is an analog characteristic difference between segments or combinations of segments in a transmitter, or when the monitoring target quantity is an analog characteristic difference between different polarization states as a whole within a dual polarization transmitter or an analog characteristic difference (amplitude, skew or frequency response difference) between segments or combinations of segments in different polarization states within a dual polarization transmitter, or, when the monitoring target quantity is an analog characteristic of the first electro-optical converter under a specific symbol or symbol sequence, analog characteristic monitoring may be performed according to the above-mentioned embodiments.

FIG. 17 is another schematic diagram of monitoring an analog characteristic of a transmitter in the embodiments of the present disclosure. If the first electro-optical converter is a directly modulated laser, direct monitoring may be performed, as shown in FIG. 17.

The above text schematically describes a method for monitoring an analog characteristic of an optical transmitter and some hardware structures for implementing the method, however the present disclosure is not limited to this. The monitoring method may further comprise other steps or processes. For specific contents of these steps or processes, please refer to related arts. In addition, the above text exemplarily describes hardware structures for implementing the monitoring method, however the present disclosure is not limited to these hardware structures, these structures may further be modified appropriately, implementations of such modifications should be included within the scope of the embodiments of the present disclosure.

In the embodiments of the present disclosure, the first electro-optical converter (a transmitter itself or part of the transmitter) generates an optical signal to-be-measured, the second electro-optical converter generates different modulated local signals according to different monitoring target quantities, and the correlation processor uses low-speed photoelectric and electrical devices to complete correlation operations of the optical signal to-be-measured and the modulated local signals, and calculates an analog characteristic of the transmitter according to correlation quantity between the optical signal to-be-measured and the modulated local signals.

In the embodiments of the present disclosure, for the correlation operation, there may be two schemes, i.e., parallel and series. In a “parallel” scheme, an addition operation is performed for the optical signal to-be-measured and the modulated local signals in an optical domain, multiplication and averaging in an electric domain are realized using a photoelectric converter. In a “series” scheme, the second electro-optical modulator directly modulates the optical signal to-be-measured, and realizes a multiplication operation of the optical signal to-be-measured and the correlation signal of the signal to-be-measured in an optical domain. Then, an average operation is realized in the electrical domain.

In the embodiments of the present disclosure, there are still multiple modes for implementation of a photoelectric converter, such as a 90° hybrid coherent receiver; a 180° hybrid and balanced photodetector; a 120° hybrid and single photodetector, etc. Multiplication in the optical domain may be achieved by series modulation.

In the embodiments of the present disclosure, when the monitoring target quantity is static analog characteristic imbalance (amplitude, phase and skew), a generated modulated local signal may be only a single signal; when the monitoring target quantity is a frequency-dependent analog characteristic difference, the generated modulated local signal may be a signal containing multiple different delays.

In the embodiments of the present disclosure, the second electro-optical converter has an advantage of reducing power consumption and hardware cost of an entire monitoring apparatus when it only has finite states.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, analog characteristic information of the optical transmitter is extracted by using the correlation of the optical signal to-be-measured and the modulated local signal, the required hardware cost is much lower than that of a conventional broadband receiver, and because there is no need to perform complex DSP, power consumption is reduced greatly.

### Embodiments of a Second Aspect

Embodiments of the present disclosure provide an apparatus for monitoring an analog characteristic of an optical transmitter, the contents same as the embodiments of the first aspect are not repeated.

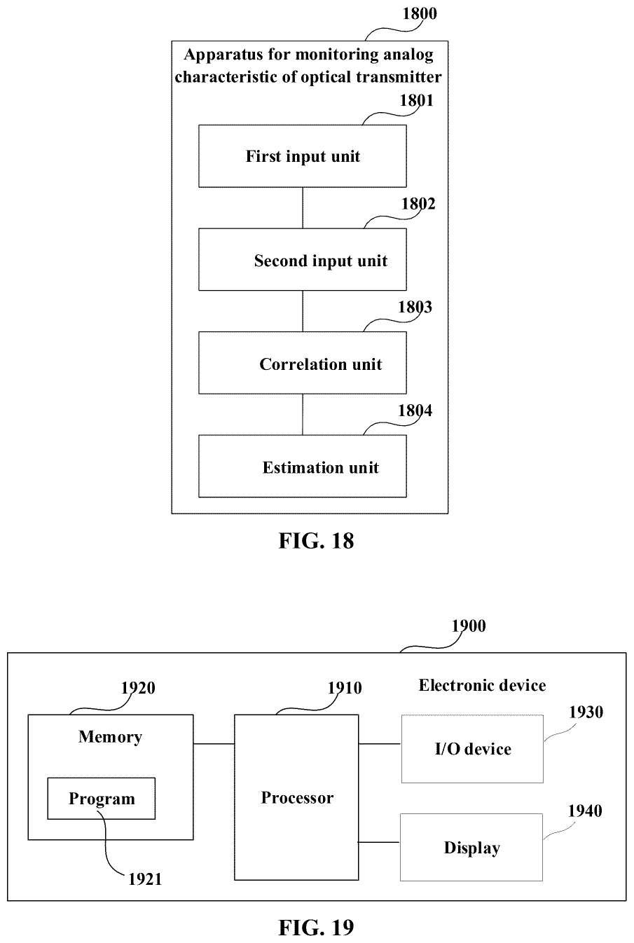

FIG. 18 is a schematic diagram of an apparatus for monitoring an analog characteristic of an optical transmitter in the embodiments of the present disclosure. As shown in FIG. 18, an apparatus for monitoring an analog characteristic of an optical transmitter includes:
a first input unit 1801, configured to input a first signal to a first electro-optical converter to obtain an optical signal to-be-measured;
a second input unit 1802, configured to input a second signal to a second electro-optical converter to obtain a modulated local signal, wherein the second signal is determined according to the first signal and a to-be-monitored analog characteristic of the first electro-optical converter;
a correlation unit 1803, configured to perform correlation processing on the optical signal to-be-measured and the modulated local signal to obtain at least one correlation quantity; and
an estimation unit 1804, configured to estimate an analog characteristic of the first electro-optical converter according to the correlation quantity.

In some embodiments, the correlation quantity represents a value of a cascaded impulse response of the first electro-optical converter and the second electro-optical converter at a first moment, and the first moment depends on a relative delay of the first signal and the second signal.

In some embodiments, in the case of transmitting at least two superimposed signals for a transmitter, each signal is monitored at least once separately to obtain at least two correlation quantities, and an analog characteristic of the first electro-optical converter is estimated according to the at least two correlation quantities.

In some embodiments, the analog characteristic is frequency-independent IQ imbalance of a coherent transmitter;
the first signal is A[n]=A_{I}[n]+jA_{Q}[n], where A_{I}[n] and A_{Q}[n] respectively represent signals loaded to an I branch and a Q branch of the coherent transmitter;
the second signal is B_{I}¹[n]=A_{I}[n] and B_{Q}¹[n]=A_{Q}[n], B_{I}¹[n] and B_{Q}¹[n] are respectively input to the second electro-optical converter successively, to generate modulated local signals E_{L-I}(t)=ΣₙB_{I}¹[n]h(t−nT) and E_{L-Q}¹(t)=ΣₙB_{Q}¹[n]h(t−nT);
or,
the second signal is B_{I}²[n]=A_{I}[n]+A_{I}[n−1]+ . . . +A_{I}[n−k] and B_{Q}²[n]32 A_{Q}[n]+A_{Q}[n−1]+ . . . +A_{Q}[n−k], k=1,2, . . . , K, B_{I}²[n] and B_{Q}²[n] are respectively input to the second electro-optical converter successively, to generate the modulated local signals E_{L-1}²(t)=ΣₙB_{I}²[n]h(t−nT) and E_{L-Q}²(t)=ΣₙB_{Q}²[n]h(t−nT).

In some embodiments, the analog characteristic is IQ skew of a coherent transmitter;
the first signal is A[n]=A_{I}[n]+jA_{Q}[n], where A_{I}[n] and A_{Q}[n] respectively represent a signal loaded to an I branch and a Q branch of a coherent transmitter,
the second signal is B_{I}³[n]=A_{I}[n]−A_{I}[n−m]and B_{Q}³[n]=A_{Q}[n]−A_{Q}[n−m], m=1,2, . . . , M, B_{I}³[n] and B_{Q}³[n] are respectively loaded at twice to the second electro-optical converter, to generate a modulated local signal

$${E}_{L - I / Q}^{3} ( t - \frac{m T}{2} ) = {\sum }_{n} {B}_{I / Q}^{3} [ n ] h ( t - \frac{m T}{2} - n T ) .$$

In some embodiments, the analog characteristic is frequency-related IQ imbalance of a coherent transmitter;
the first signal is A[n]=A_{I}[n]+jA_{Q}[n], where A_{I}[n] and A_{Q}[n] respectively represent signals loaded to an I branch and a Q branch of the coherent transmitter;
the second signal is B_{I/Q}^{4(q)}[n]=A_{I/Q}[n], B_{I}^{4(q)}[n] and B_{Q}^{4(q)}[n] are respectively input to the second electro-optical converter, to generate a modulated local signal E_{L-I/Q}^{4(q)}(t−(q−1)τ)=ΣₙA_{I/Q}[n]h(t−(q−1)τ−nT), 1≤q≤Y, q is an integer, Y is an empirical value selected according to an analog characteristic of a transmitter to-be-measured, and τ is a unit delay less than T;
or,
when (q−1)τ=mT+δ, 0≤δ<T, the second signal is B_{I/Q}^{4(q)}[n]=A_{I/Q}[n−m], B_{I}^{4(q)}[n] and B_{Q}^{4(q)}[n] are respectively input to the second electro-optical converter, to generate a modulated local signal E_{L-I/Q}^{4(q)}(t−(q−1)τ)=ΣₙA_{I/Q}[n−m]h(t−σ−nT).

In some embodiments, the analog characteristic is a frequency-independent difference between different segments or between different combinations of segments assigned according to bits within a transmitter;
the first signal is a signal A₍ⱼ₎[n] loaded onto a segment or a combination of segments assigned by a j^{th} bit;
the second signal is B₍ⱼ₎⁵[n]=A₍ⱼ₎[n], B₍ⱼ₎⁵[n] is respectively input to the second electro-optical converter, to generate the modulated local signal E_{L(j)}⁵(t)=ΣₙB₍ⱼ₎⁵[n]h(t−nT).
or,
the second signal is B₍ⱼ₎⁶[n]=A₍ⱼ₎[n]+A₍ⱼ₎[n−1]+ . . . +A₍ⱼ₎[n−k], k=1,2, . . . , K, B₍ⱼ₎⁶[n] is respectively input to the second electro-optical converter, to generate the modulated local signal E_{L(j)}⁶⁾(t)=ΣₙB₍ⱼ₎⁶[n]h(t−nT).

In some embodiments, the analog characteristic is a skew difference between different segments or between different combinations of segments assigned according to bits within a transmitter;
the first signal is a signal A₍ⱼ₎[n] loaded onto a segment or a combination of segments assigned by a j^{th} bit;
the second signal is B₍ⱼ₎⁷[n]=A₍ⱼ₎[n]−A₍ⱼ₎[n−m], B₍ⱼ₎⁷[n] is respectively input to the second electro-optical converter, to generate the modulated local signal

$${E}_{L ( j )}^{7} ( t - \frac{m T}{2} ) = {\sum }_{n} {B}_{( j )}^{7} [ n ] h ( t - \frac{m T}{2} - n T ) .$$

In some embodiments, the analog characteristic is a frequency-related difference between different segments or between different combinations of segments assigned according to bits within a transmitter;
the first signal is a signal A₍ⱼ₎[n] loaded onto a segment or a combination of segments assigned by a j^{th} bit;
the second signal is B₍ⱼ₎^{8(q)}=A₍ⱼ₎[n], B₍ⱼ₎^{8(q)} is respectively input to the second electro-optical converter, to generate the modulated local signal E_{L(j)}^{8(q)}(t−(q−1)+)=ΣₙA₍ⱼ₎[n](t−(q−1) τ−nT), 1≤q≤Y, q is an integer, Y is an empirical value selected according to an analog characteristic of a transmitter to-be-measured, and τ is a unit delay less than T;
or,
when (q−1)τ=mT+δ, 0≤δ<T, the second signal is B₍ⱼ₎^{8(q)}=A₍ⱼ₎[n−m], B₍ⱼ₎^{8(q)} is respectively input to the second electro-optical converter, to generate the modulated local signal E_{L(j)}^{8(q)}(t−(q−1)τ)=ΣₙA₍ⱼ₎[n−m]h(t−δ−nT).

In some embodiments, the analog characteristic is a difference between different polarization states as a whole within a dual polarization transmitter or a difference between different segments or between different combinations of segments assigned according to bits in different polarization states within a dual polarization transmitter;

H and V respectively represent an H polarization state and a V polarization state of the dual polarization transmitter, and second signals of H branch and V branch of the dual polarization transmitter are B_{H}⁹[n] and B_{V}⁹[n] respectively.

In some embodiments, the analog characteristic is an analog characteristic of the first electro-optical converter under a specific symbol or a specific symbol sequence; the first signal is expressed as A[n], the second signal B¹⁰[n] is a constant when corresponding to the specific symbol, or, the second signal B¹¹[n] is a constant when corresponding to a central symbol of the specific symbol sequence, and the modulated local signal is a pulse signal.

In some embodiments, the analog characteristic is static and dynamic analog characteristics of each segment within a transmitter with a multi-segment modulator cascaded structure; a first signal of a segment to-be-measured is A₍ₛ₎[n], and a first signal of a not-to-be measured segment is A_{(w)}[n]=0, w≠s;
the second signal is B₍ₛ₎^{12(q)}=A₍ₛ₎[n], B₍ₛ₎^{12(q)} is respectively input to the second electro-optical converter, to generate the modulated local signal E_{L(s)}^{12(q)}(t−(q−1)τ)=ΣₙA₍ₛ₎[n]h(t−(q−1) τ−nT), 1≤q≤Y, q is an integer, and τ is a unit delay less than T;
or,
when (q−1)τ=mT+δ, 0≤δ<T, the second signal is B₍ₛ₎^{12(q)}=A₍ₛ₎[n−m], B₍ₛ₎^{12(q)} is respectively input to the second electro-optical converter, to generate the modulated local signal E_{L(s)}^{12(q)}(t−(q−1)τ)=ΣₙA₍ₛ₎[n−m]h(t−δ−nT).

In some embodiments, the apparatus further includes: a quantization unit, configured to quantify the first signal or the second signal by using at least one bit, and input a quantized signal to the second electro-optical converter to obtain the modulated local signal.

In some embodiments, the first electro-optical converter is a transmitter, or is a partial modulation unit of the transmitter, or is a direct modulation laser.

In some embodiments, the second electro-optical converter outputs a finite number of states.

In some embodiments, the first electro-optical converter and the second electro-optical converter are connected in parallel; the first electro-optical converter generates the optical signal to-be-measured based on an optical carrier and the first signal, and the second electro-optical converter generates the modulated local signal based on the optical carrier and the second signal; the optical signal to-be-measured and the modulated local signal are respectively input to a photoelectric multiplier to obtain a product electrical signal; and the product electrical signal generates at least one correlation after being electrically averaged.

In some embodiments, the first electro-optical converter and the second electro-optical converter are connected in series; the first electro-optical converter generates the optical signal to-be-measured based on an optical carrier and the first signal, and the second electro-optical converter generates the modulated local signal based on the optical signal to-be-measured and the second signal; the modulated local signal is input to a photoelectric converter to obtain an electrical signal; and the electrical signal generates at least one correlation after being electrically averaged.

It's worth noting that the above only describes components or modules related to the present disclosure, but the present disclosure is not limited to this. The apparatus 1800 for monitoring an analog characteristic of an optical transmitter may further include other components or modules. For detailed contents of these components or modules, relevant technologies may be referred to.

For the sake of simplicity, FIG. 18 only exemplarily shows a connection relationship or signal direction between components or modules, however persons skilled in the art should know that various relevant technologies such as bus connection may be used. The above components or modules can be realized by a hardware facility such as a processor, a memory, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, analog characteristic information of the optical transmitter is extracted by using the correlation of the optical signal to-be-measured and the modulated local signal, the required hardware cost is much lower than that of a conventional broadband receiver, and because there is no need to perform complex DSP, power consumption is reduced greatly.

### Embodiments of a Third Aspect

The embodiments of the present disclosure provide an electronic device, including the apparatus 1800 for monitoring an analog characteristic of an optical transmitter as described in the embodiments of the second aspect, whose contents are incorporated here. The electronic device may be, for example, a computer, server, a workstation, a laptop computer, a smartphone, etc.; however, the embodiments of the present disclosure are not limited to this.

FIG. 19 is a schematic diagram of an electronic device in the embodiments of the present disclosure. As shown in FIG. 19, an electronic device 1900 may include: a processor (such as a central processing unit (CPU)) 1910 and a memory 1920; the memory 1920 is coupled to the central processing unit 1910. The memory 1920 may store various data; moreover, further stores a program 1921 for information processing, and executes the program 1921 under the control of the processor 1910.

In some embodiments, the function of the apparatus 1800 for monitoring an analog characteristic of an optical transmitter is integrated into the processor 1910 for implementation. The processor 1910 is configured to implement the method for monitoring an analog characteristic of an optical transmitter as described in the embodiments of the first aspect.

In some embodiments, the apparatus 1800 for monitoring an analog characteristic of an optical transmitter is configured separately from the processor 1910, for example the apparatus 1800 for monitoring an analog characteristic of an optical transmitter is configured as a chip connected to the processor 1910, a function of the apparatus 1800 for monitoring an analog characteristic of an optical transmitter is realized through the control of the processor 1910.

For example, the processor 1910 is configured to perform the following control: inputting a first signal to a first electro-optical converter to obtain an optical signal to-be-measured; inputting a second signal to a second electro-optical converter to obtain a modulated local signal, wherein the second signal is determined according to the first signal and a to-be-monitored analog characteristic of the first electro-optical converter; performing correlation processing on the optical signal to-be-measured and the modulated local signal to obtain at least one correlation; and estimating an analog characteristic of the first electro-optical converter according to the correlation.

In addition, as shown in FIG. 19, the electronic device 1900 may further include: an input/output (I/O) device 1930 and a display 1940, etc., wherein the functions of said components are similar to relevant arts, and are not repeated here. It's worth noting that the electronic device 1900 does not have to include all the components shown in FIG. 19. Moreover, the electronic device 1900 may also include components not shown in FIG. 19, relevant technologies may be referred to.

Embodiments of the present disclosure further provides an optical transmitter is provided, including a first electro-optical converter and a second electro-optical converter, characterized in that a first signal is input to the first electro-optical converter to obtain an optical signal to-be-measured; a second signal is input to the second electro-optical converter to obtain a modulated local signal; wherein the second signal is determined according to the first signal and a to-be-monitored analog characteristic of the first electro-optical converter; the optical transmitter further includes a monitoring apparatus, configured to perform correlation processing on the optical signal to-be-measured and the modulated local signal to obtain at least one correlation; and estimate an analog characteristic of the first electro-optical converter according to the correlation.

The embodiments of the present disclosure further provide a computer readable program, wherein when an electronic device executes the program, the program enables a computer to execute the method for monitoring an analog characteristic of an optical transmitter as described in the embodiments of the first aspect, in the electronic device.

The embodiments of the present disclosure further provide a storage medium in which a computer readable program is stored, wherein the computer readable program enables a computer to execute the method for monitoring an analog characteristic of an optical transmitter as described in the embodiments of the first aspect, in the electronic device.

The apparatus and method in the present disclosure may be realized by hardware, or may be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/apparatus described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the principle of the present disclosure, these variations and modifications are also within the scope of the present disclosure.

1. An apparatus to monitor an analog characteristic of an optical transmitter, comprising:
a processor coupled to a memory and configured to,
input a first signal to a first electro-optical converter to obtain an optical signal to-be-measured;
input a second signal to a second electro-optical converter to obtain a modulated local signal, wherein the second signal is determined according to the first signal and a to-be-monitored analog characteristic of the first electro-optical converter;
perform correlation processing on the optical signal to-be-measured and the modulated local signal to obtain at least one correlation quantity; and
estimate an analog characteristic of the first electro-optical converter according to the at least one correlation quantity.

2. The apparatus according to claim 1, wherein the at least one correlation quantity represents a value of a cascaded impulse response of the first electro-optical converter and the second electro-optical converter at a first moment, and the first moment depends on a relative delay of the first signal and the second signal.

3. The apparatus according to claim 1, wherein in case of the first electro-optical converter as a transmitter transmitting at least two superimposed signals, each signal of the at least two superimposed signals is monitored at least once by at least one correlation processing separately to obtain at least two correlation quantities, and the analog characteristic of the first electro-optical converter is estimated according to the at least two correlation quantities.

4. The apparatus according to claim 1, wherein the analog characteristic is frequency-independent IQ imbalance of the first electro-optical converter as a coherent transmitter;
the first signal is A[n]=A_{I}[n]+jA_{Q}[n], where A_{I}[n] and A_{Q}[n] respectively represent signals loaded to an I branch and a Q branch of the coherent transmitter;
the second signal is B_{I}¹[n]=A_{I}[n] and B_{Q}¹[n]=A_{Q}[n], B_{I}¹[n] and B_{Q}¹[n] are respectively input to the second electro-optical converter successively, to generate the modulated local signal E_{L-1}¹(t)=ΣₙB_{I}¹[n]h(t−nT) and E_{L-Q}¹(t)=ΣₙB_{Q}¹[n]h(t−nT);
or,
the second signal is B_{I}²[n]=A_{I}[n]+A_{I}[n−1]+ . . . +A_{I}[n−k] and B_{Q}²[n]=A_{Q}[n]+A_{Q}[n−1]+ . . . +A_{Q}[n−k], k=1,2, . . . , K, B_{I}²[n] and B_{Q}²[n] are respectively input to the second electro-optical converter successively, to generate the modulated local signal E_{L-I}²(t)=ΣₙB_{I}²[n]h(t−nT) and E_{L-Q}²(t)=ΣₙB_{Q}²[n]h(t−nT).

5. The apparatus according to claim 1, wherein the analog characteristic is IQ skew of the first electro-optical converter as a coherent transmitter;
the first signal is A[n]=A_{I}[n]+jA_{Q}[n], where A_{I}[n] and A_{Q}[n] respectively represent signals loaded to an I branch and a Q branch of the coherent transmitter;
the second signal is B_{I}³[n]=A_{I}[n]−A_{I}[n−m] and B_{Q}³[n]=A_{Q}[n]−A_{Q}[n−m], m=1, 2, . . . , M, B_{I}³[n] and B_{Q}³[n] are respectively input to the second electro-optical converter successively, to generate the modulated local signal
$${E}_{L - I / Q}^{3} ( t - \frac{m T}{2} ) = {\sum }_{n} {B}_{I / Q}^{3} [ n ] h ( t - \frac{m T}{2} - n T ) .$$

6. The apparatus according to claim 1, wherein the analog characteristic is frequency-dependent IQ imbalance of the first electro-optical converter as a coherent transmitter;
the first signal is A[n]=A_{I}[n]+jA_{Q}[n], where A_{I}[n] and A_{Q}[n] respectively represent signals loaded to an I branch and a Q branch of the coherent transmitter;
the second signal is B_{I/Q}⁴[n]=A_{I/Q}[n], B_{I}^{4(q)}[n] and B_{Q}^{4(q)}[n] are respectively input to the second electro-optical converter successively, to generate the modulated local signal E_{L-I/Q}^{4(q)}(t−(q−1)τ)=ΣₙA_{I/Q}[n]h(t−(q−1)τ−nT), 1≤q≤Y, q is an integer, Y is an empirical value selected according to an analog characteristic of a transmitter to-be-measured, and τ is a unit delay less than T;
or,
when (q−1)τ=mT+δ,0≤δT, the second signal is B_{I/Q}^{4(q)}[n]=A_{I/Q}[n−m], B_{I}^{4(q)}[n] and B_{Q}^{4(q)}[n] are respectively input to the second electro-optical converter successively, to generate a modulated local signal E_{L-I/Q}^{4(q)}(t−(q−1)τ)=ΣₙA_{I/Q}[n−m]h(t−σ−nT).

7. The apparatus according to claim 1, wherein the analog characteristic is a frequency-independent difference between different segments or between different combinations of segments assigned according to bits within the first electro-optical converter as a transmitter;
the first signal is a signal A₍ⱼ₎[n] loaded onto a segment or a combination of segments assigned by a jth bit;
the second signal is B₍ⱼ₎⁵[n]=A₍ⱼ₎[n], B₍ⱼ₎⁵[n] is respectively input to the second electro-optical converter successively, to generate the modulated local signal E_{L(j)}⁵⁾(t)=ΣₙB₍ⱼ₎⁵[n]h(t−nT).;
or,
the second signal is B₍ⱼ₎⁶[n]=A₍ⱼ₎[n]+A₍ⱼ₎[n−1]+ . . . +A₍ⱼ₎[n−k], k=1,2, . . . , K, B₍ⱼ₎⁶[n] is respectively input to the second electro-optical converter successively, to generate the modulated local signal E_{L(j)}⁶(t)=ΣₙB₍ⱼ₎⁶[n]h(t−nT).

8. The apparatus according to claim 1, wherein the analog characteristic is a skew difference between different segments or between different combinations of segments assigned according to bits within the first electro-optical converter as a transmitter;
the first signal is a signal A₍ⱼ₎[n] loaded onto a segment or a combination of segments assigned by a j^{th} bit;
the second signal is B₍ⱼ₎⁷[n]=A₍ⱼ₎[n]−A₍ⱼ₎[n−m], B₍ⱼ₎⁷[n] is respectively input to the second electro-optical converter successively, to generate the modulated local signal
$${E}_{L ( j )}^{7} ( t - \frac{m T}{2} ) = {\sum }_{n} {B}_{( j )}^{7} [ n ] h ( t - \frac{m T}{2} - n T ) .$$

9. The apparatus according to claim 1, wherein the analog characteristic is a frequency-dependent difference between different segments or between different combinations of segments assigned according to bits within the first electro-optical converter as a transmitter;
the first signal is a signal A₍ⱼ₎[n] loaded onto a segment or a combination of segments assigned by a j^{th} bit;
the second signal is B₍ⱼ₎^{8(q)}=A₍ⱼ₎[n], B₍ⱼ₎^{8(q)} is respectively input to the second electro-optical converter successively, to generate the modulated local signal E_{L(j)}^{8(q)}(t−(q−1)τ)=ΣₙA₍ⱼ₎[n]h(t−(q−1)τ−nT), 1≤q≤Y, q is an integer, Y is an empirical value selected according to an analog characteristic of a transmitter to-be-measured, and τ is a unit delay less than T;
or,
when (q−1)τ=mT+δ, 0≤δ<T, the second signal is B₍ⱼ₎^{8(q)}=A₍ⱼ₎[n−m], B₍ⱼ₎^{8(q)} is respectively input to the second electro-optical converter successively, to generate the modulated local signal E_{L(j)}^{8(q)}(t−(q−1)τ)=ΣₙA₍ⱼ₎[n−m]h(t−δ−nT).

10. The apparatus according to claim 1, wherein the analog characteristic is a difference between different polarization states as a whole within the first electro-optical converter as a dual polarization transmitter, or a difference between different segments or between different combinations of segments assigned according to bits in different polarization states within the dual polarization transmitter;
H and V respectively represent an H polarization state and a V polarization state of the dual polarization transmitter, and second signals of H branch and V branch of the dual polarization transmitter are B_{H}⁹[n] and B_{V}⁹[n] respectively.

11. The apparatus according to claim 1, wherein the analog characteristic is an analog characteristic of the first electro-optical converter under a specific symbol or a specific symbol sequence;
the first signal is expressed as A[n], the second signal B¹⁰[n] is a constant when corresponding to the specific symbol, or,
the second signal B¹¹[n] is a constant when corresponding to a central symbol of the specific symbol sequence, and the modulated local signal is a pulse signal.

12. The apparatus according to claim 1, wherein the analog characteristic is static and dynamic analog characteristics of each segment within the first electro-optical converter as a transmitter with a multi-segment modulator cascaded structure;
a first signal of a segment to-be-measured is A₍ₛ₎[n], and a first signal of a not-to-be measured segment is A_{(w)}[n]=0, w≠s;
the second signal is B₍ₛ₎^{12(q)}=A₍ₛ₎[n], B₍ₛ₎^{12(q)} is respectively input to the second electro-optical converter successively, to generate the modulated local signal E_{L(s)}^{12(q)}(t−(q−1)τ)=ΣₙA₍ₛ₎[n]h(t−(q−1)τ−nT), 1≤q≤Y, q is an integer, and τ is a unit delay less than T;
or,
when (q−1)τ=mT+δ, 0≤δ<T, the second signal is B₍ₛ₎^{12(q)}=A₍ₛ₎[n−m], B₍ₛ₎^{12(q)} is respectively input to the second electro-optical converter successively, to generate the modulated local signal E_{L(s)}^{12(q)}(t−(q−1)τ)=ΣₙA₍ₛ₎[n−m]h(t−δ−nT).

13. The apparatus according to claim 1, wherein the processor is further configured to:
quantify the first signal or the second signal by using at least one bit, and input a quantized signal to the second electro-optical converter to obtain the modulated local signal.

14. The apparatus according to claim 1, wherein the first electro-optical converter is a transmitter, or is a partial modulator of the transmitter, or is a direct modulation laser;
the second electro-optical converter outputs a finite number of states.

15. The apparatus according to claim 1, wherein
the first electro-optical converter and the second electro-optical converter are connected in parallel;
the first electro-optical converter generates the optical signal to-be-measured based on an optical carrier and the first signal, and the second electro-optical converter generates the modulated local signal based on the optical carrier and the second signal;
the optical signal to-be-measured and the modulated local signal are respectively input to a photoelectric multiplier to obtain a product electrical signal; and
the product electrical signal generates at least one correlation quantity after being electrically averaged.

16. The apparatus according to claim 1, wherein
the first electro-optical converter and the second electro-optical converter are connected in series;
the first electro-optical converter generates the optical signal to-be-measured based on an optical carrier and the first signal, and the second electro-optical converter generates the modulated local signal based on the optical signal to-be-measured and the second signal;
the modulated local signal is input to a photoelectric converter to obtain an electrical signal; and
the electrical signal generates at least one correlation quantity after being electrically averaged.

17. A method of monitoring an analog characteristic of an optical transmitter, comprising:
inputting a first signal to a first electro-optical converter to obtain an optical signal to-be-measured;
inputting a second signal to a second electro-optical converter to obtain a modulated local signal, wherein the second signal is determined according to the first signal and a to-be-monitored analog characteristic of the first electro-optical converter;
performing correlation processing on the optical signal to-be-measured and the modulated local signal to obtain at least one correlation quantity; and
estimating an analog characteristic of the first electro-optical converter according to the at least one correlation quantity.

18. An optical transmitter, comprising:
a first electro-optical converter and a second electro-optical converter, configured for a first signal to be input to the first electro-optical converter to obtain an optical signal to-be-measured; and
a second signal to be input to the second electro-optical converter to obtain a modulated local signal, the second signal determined according to the first signal and a to-be-monitored analog characteristic of the first electro-optical converter, so that a monitoring apparatus is configurable to
perform correlation processing on the optical signal to-be-measured and the modulated local signal to obtain at least one correlation quantity; and
estimate an analog characteristic of the first electro-optical converter according to the at least one correlation quantity.
